(19) United States
(12) Patent Application Publication
(10) Pub. No.: US 2026/0347236 A1
(43) Pub. Date: Nov. 5, 2026

(54) FUSION-FORMED GLASS ARTICLES EXHIBITING MINIMAL OPTICAL DISTORTION AND ASSOCIATED METHODS

(71) Applicant: CORNING INCORPORATED, CORNING, NY (US)

(72) Inventors: Eric Michael Gross, Pittsburgh, PA (US); Philip Robert LeBlanc, Corning, NY (US); Maximilian Josef Waldherr, Petershausen (DE)

(21) Appl. No.: 19/486,632

(22) PCT Filed: May 13, 2024
(86) PCT No.: PCT/US2024/029075

§ 371 Date: Nov. 21, 2025

Related U.S. Application Data
(60) Provisional application No. 63/471,895, filed on Jun. 8, 2023.
(60) Provisional application No. 63/530,174, filed on Aug. 1, 2023.

(51) Int. Cl. C03C 3/091

(52) U.S. Cl. CPC C03C 3/091; C03C 2203/10

(57) ABSTRACT

Disclosed herein are embodiments of a borosilicate glass composition as may be useful for windshield and other applications in particular due to unique fracture behavior.

### CROSS-REFERENCE TO RELATED APPLICATIONS

This application claims the benefit of priority of U.S. Provisional Application Ser. No. 63/530,174, filed on Aug. 1, 2023; and U.S. Provisional Application Ser. No. 63/471,895, filed on Jun. 8, 2023, the contents of which are relied upon and incorporated herein by reference in their entireties.

### FIELD

The present disclosure relates to glass articles and, more particularly, to glass articles exhibiting relatively low optical distortion as compared to glass articles fabricated with certain existing fabrication methods, and methods for forming the same.

### BACKGROUND

Many applications benefit from glass articles that exhibit relatively low optical distortion. Automotive glass is an example of such an application. With increased connectivity of vehicles, more active components (e.g., advanced driver assistance systems (ADAS), sensors, cameras, and the like) are being incorporated into vehicles. For example, certain vehicles may employ an imaging system to detect one or more aspects of the operating environment of the vehicle to provide feedback to vehicle components. Certain applications may benefit from imaging systems with particularly high resolution. Such higher resolution may be rendered possible through advancements in imaging components (e.g., detector arrays). As a result, vehicle manufacturers may employ higher resolution imaging systems in vehicles. Such systems may be deployed behind glass components of the vehicle (e.g., a windshield or other glazing, a separate protective window), and so any optical distortion induced by such glass components may directly affect the ability to entirely realize the benefits of high resolution systems.

Glass production methods are known to introduce thickness variations into the resultant articles. Such thickness variations are directional in that they may, for example, be generally oriented in a direction in which molten glass is stretched during the production process. Float production methods, for example, may result in glass articles with thickness variations across a direction in which the glass travels. Down-draw methods may result in vertically-oriented drawlines such that the thickness of the glass article varies in a direction perpendicular to the down-draw direction (e.g., represented by gravity). While down-draw methods generally exhibit thickness variations that are lower in amplitude than those associated with float methods, they can still be problematic from an optical distortion perspective for certain applications because such thickness variations represent areas of localized curvature. Such areas of localized curvature generally impart unintended optical power into the glass article, which may cause various existing glass articles to have unacceptably high levels of optical distortion due to localized lensing effects from the curvature.

Accordingly, a need exists for glass articles that exhibit minimal levels of optical distortion and methods of fabricating the same.

### SUMMARY

The present disclosure minimize optical distortion by application of energy to softened glass during the formation of various glass articles in areas where it has been determined there is a high likelihood of elevated optical distortion if the softened glass were allowed to solidify into a glass article in a down-draw process. The energy may be applied in the form of a laser with a relatively limited heat affected zone (e.g., less than 100 mm) so as to mitigate (or even eliminate) localized regions of elevated curvature in the glass article. The laser can be controlled based on detected (or estimated) areas of high thickness slope or curvature, or, as described herein, based on direct measurements of optical distortion, rather than a specific thickness target. Energy is applied to the glass with the object of mitigating localized curvature and/or thickness changes rather than to achieve a particular target thickness so as to provide glass articles exhibiting relatively low optical distortion as compared to those fabricated using certain existing processes. As described herein, the articles described herein can exhibit relatively low levels of vertical optical distortion (“VOD”) and horizontal optical distortion (“HOD”), as measured using a commercially available distortion gage, such as the SCREENSCAN-Faultfinder®, supplied by ISRA VISION AG. In embodiments suitable for automotive applications, for example, the glass articles described herein can exhibit a sum of HOD and VOD values that is less than or equal to 80 millidiopters or even less than or equal to 50 millidiopters, or even less than 20 millidiopters, when measured at a 60° inclination angle and a 20° cross-viewing angle. This is below that achievable with certain existing methods (e.g., float-formed soda lime silicate glasses), especially at relatively high thicknesses (e.g., greater than or equal to 2.0 mm, greater than or equal to 3.0 mm, greater than or equal to 3.5 mm).

An aspect (1) of the present disclosure pertains to a glass article comprising: a first major surface; a second major surface disposed opposite the first major surface; a thickness measured between the first major surface and the second major surface in a direction perpendicular to the first and second major surfaces; and a plurality of drawlines extending in a first direction, wherein: the thickness is greater than or equal to 0.05 mm and less than or equal to 6.0 mm, the glass article exhibits a maximum vertical optical distortion (VOD), with a vertical direction being parallel to the first direction, that is less than or equal to 16 millidiopters when the glass article is oriented at an inclination angle of 60° relative to the vertical direction, and the glass article exhibits a maximum horizontal optical distortion (HOD), with a horizontal direction being perpendicular to the vertical direction, that is less than or equal to 60 millidiopters when the glass article is oriented at a cross-viewing angle of 20° relative to the horizontal direction.

An aspect (2) of the present disclosure pertains to a glass article according to the aspect (1), wherein a sum of the VOD and the HOD is less than or equal to 20 millidiopters.

An aspect (3) of the present disclosure pertains to a glass article according to any of the aspects (1)-(2), wherein 6 millidiopters VOD 10 millidiopters.

An aspect (4) of the present disclosure pertains to a glass article according to any of the aspects (1)-(3), wherein 6 millidiopters HOD 10 millidiopters.

An aspect (5) of the present disclosure pertains to a glass article according to any of the aspects (1)-(4), wherein: the glass article comprises a length measured in the horizontal direction, the length is greater than or equal to 500 mm, and along a line in the horizontal direction having a profile length that is at least 50% of the length, thickness comprises a range that is greater than or equal to 0.05% of an average value of the thickness along the line and less than or equal to 5.0% of the average value.

An aspect (6) of the present disclosure pertains to a glass article according to the aspect (5), wherein the length is greater than or equal to 2000 mm.

An aspect (7) of the present disclosure pertains to a glass article according to any of the aspects (5)-(6), wherein a 500 mm segment of the line comprises a range of predicted optical distortion values, calculated as 0.5 times a second derivative of a thickness profile along the line, that is less than or equal to 2.0 millidiopters.

An aspect (8) of the present disclosure pertains to a glass article according to the aspect (7), wherein a maximum magnitude of the predicted optical distortion values (in millidiopters) is less than 80% of the average thickness (in mm).

An aspect (9) of the present disclosure pertains to a glass article according to any of the aspects (6)-(8), wherein the range of predicted optical distortion values is less than 150% of the average thickness (in mm).

An aspect (10) of the present disclosure pertains to a glass article according to any of the aspects (6)-(9), wherein the predicted optical distortion values are less than 0.5 millidiopters over a majority of 500 mm segment.

An aspect (11) of the present disclosure pertains to a glass article according to any of the aspects (1)-(10), wherein an average value of the thickness is greater than or equal to 2.0 mm.

An aspect (12) of the present disclosure pertains to a glass article according to the aspect (11), wherein the average value of the thickness is greater than or equal to 3.0 mm and less than or equal to 4.0 mm.

An aspect (13) of the present disclosure pertains to a glass article according to any of the aspects (1)-(12), wherein the glass article comprises a borosilicate glass composition.

An aspect (14) of the present disclosure pertains to a glass article comprising: a first major surface; a second major surface disposed opposite the first major surface; and a thickness measured between the first major surface and the second major surface in a direction perpendicular to the first and second major surfaces, wherein: the thickness comprises an average value that is greater than or equal to 0.05 mm and less than or equal to 4.0 mm along a line extending between edges of the glass article in a first direction, thickness comprises a range that is greater than or equal to 0.05% of an average value of the thickness along the line and less than or equal to 5.0% of the average value, and a 500 mm segment of the line comprises a range of predicted optical distortion values, calculated as 0.5 times a second derivative of a thickness profile along the line, that is less than or equal to 2.0 millidiopters.

An aspect (15) of the present disclosure pertains to a glass article according to the aspect (14), wherein the average value is greater than or equal to 2.0 mm.

An aspect (16) of the present disclosure pertains to a glass article according to the aspect (15), wherein the average value of the thickness is greater than or equal to 3.0 mm and less than or equal to 4.0 mm.

An aspect (17) of the present disclosure pertains to a glass article according to any of the aspects (15)-(16), wherein a maximum magnitude of the predicted optical distortion values (in millidiopters) is less than 80% of the average value (in mm).

An aspect (18) of the present disclosure pertains to a glass article according to any of the aspects (15)-(17), wherein the range of predicted optical distortion values is less than 150% of the average value (in mm).

An aspect (19) of the present disclosure pertains to a glass article according to any of the aspects (15)-(18), wherein the predicted optical distortion values are less than 0.5 millidiopters over a majority of the 500 mm segment.

An aspect (20) of the present disclosure pertains to a glass article according to any of the aspects (15)-(19), wherein the glass article comprises a length measured in the first direction, the length being greater than or equal to 1000 mm.

An aspect (21) of the present disclosure pertains to a glass article according to the aspect (20), wherein: the glass article exhibits a maximum vertical optical distortion (VOD), with a vertical direction being perpendicular to the first direction, that is less than or equal to 16 millidiopters when the glass article is oriented at an inclination angle of 60° relative to the vertical direction, and the glass article exhibits a maximum horizontal optical distortion (HOD), with a horizontal direction being perpendicular to the vertical direction, that is less than or equal to 25 millidiopters when the glass article is oriented at a cross-viewing angle of 20° relative to the horizontal direction.

An aspect (22) of the present disclosure pertains to a glass article according to the aspect (21), wherein a sum of the VOD and the HOD is less than or equal to 20 millidiopters.

An aspect (23) of the present disclosure pertains to a glass article according to any of the aspects (21)-(22), wherein 6 millidiopters VOD 10 millidiopters.

An aspect (24) of the present disclosure pertains to a glass article according to any of the aspects (21)-(23), wherein 6 millidiopters HOD 10 millidiopters.

An aspect (25) of the present disclosure pertains to a glass article according to any of the aspects (15)-(24), wherein the glass article comprises a borosilicate glass composition.

An aspect (26) of the present disclosure pertains to a method of fabricating a glass article, the method comprising: measuring a thickness profile along a width of an initial ribbon of glass-forming material; generating a target thickness profile by removing high spatial frequency thickness variations from the thickness profile to generate a smoothed thickness profile and offsetting the smoothed thickness profile, wherein the target thickness profile comprises a non-constant thickness; and applying laser power to the glass-forming material based on differences between the measured thickness profile and the target thickness profile when the glass-forming material is in a viscous state, wherein the laser power varies along the width as the glass-forming material is traveling in a direction perpendicular to a direction in which the width is measured.

An aspect (27) of the present disclosure pertains to a method according to the aspect (26), wherein the target thickness profile comprises a range over a 500 mm segment thereof that is greater than 20 μm.

An aspect (28) of the present disclosure pertains to a method according to any of the aspects (26)-(27), wherein applying the laser power comprises changing the power supplied to a CO₂ laser in proportion to a magnitude of a difference between the measured profile and the target thickness profile.

An aspect (29) of the present disclosure pertains to a method according to any of the aspects (26)-(28), wherein the smoothed thickness profile is down-shifted by at least a maximum difference between the smoothed thickness profile and the measured thickness profile.

An aspect (30) of the present disclosure pertains to a method according to the aspect (29), wherein laser power is applied to at least 80% of a width of a subsequent ribbon the of the glass forming material.

An aspect (31) of the present disclosure pertains to a method according to the aspect (29), wherein the target thickness profile deviates from a nominal target value for a thickness of the ribbon by more than 10 μm.

An aspect (32) of the present disclosure pertains to a method according to any of the aspects (30)-(31), wherein the nominal target value is greater than or equal to 3.0 mm.

An aspect (33) of the present disclosure pertains to a method according to any of the aspects (26)-(30), further comprising periodically measuring a nominal thickness profile of the ribbon, the nominal thickness profile representing a thickness profile generated by a glass-forming apparatus without the ribbon being modified by laser energy, wherein an amount of laser power that is applied to the ribbon is varied based on the nominal thickness profile.

An aspect (34) of the present disclosure pertains to a method according to the aspect (30), wherein the applying the laser power comprises automatically computing a vector of laser power values using a model predictive control framework based on the nominal thickness profile.

An aspect (35) of the present disclosure pertains to a method of fabricating a glass article, the method comprising: measuring an optical distortion map along a width of an initial ribbon of glass-forming material with an optical distortion gauge; and applying laser power to the glass-forming material based on differences between optical distortion values of the optical distortion map and target optical distortion values, wherein the laser power varies along the width as the glass-forming material is traveling in a direction perpendicular to a direction in which the width is measured.

An aspect (36) of the present disclosure pertains to a method according to the aspect (35), wherein the target optical distortion values are 0 millidiopters.

An aspect (37) of the present disclosure pertains to a method according to any of the aspects (35)-(36), wherein the optical distortion map comprises at least one of a vertical optical distortion map and a horizontal optical distortion map.

An aspect (38) of the present disclosure pertains to a method according to the aspect (37), wherein the optical distortion map comprises a combination of the vertical and horizontal optical distortion maps.

An aspect (39) of the present disclosure pertains to a method according to any of the aspects (35)-(36), further comprising periodically measuring a nominal optical distortion map of the ribbon, the nominal optical distortion map representing an optical distortion map generated by a glass-forming apparatus without the ribbon being modified by laser energy, wherein an amount of laser power that is applied to the ribbon is varied based on the nominal optical distortion map.

An aspect (40) of the present disclosure pertains to a method according to the aspect (39), wherein the applying the laser power comprises automatically computing a vector of laser power values using a model predictive control framework based on the nominal optical distortion map.

An aspect (41) of the present disclosure pertains to a method according to any of the aspects (35)-(40), wherein the applying the laser power comprises periodically computing a vector of laser power values such that the laser power mitigates localized peaks in the optical distortion map.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and the operation of the various embodiments.

### BRIEF DESCRIPTION OF THE DRAWINGS

FIG. 1A is a side view of a vehicle in an external environment, illustrating a sensing system on a roof of the vehicle and another system on a forward portion of the vehicle, according to one or more embodiments of the present disclosure;

FIG. 1B schematically depicts one of the sensing systems of the vehicle depicted in FIG. 1A, according to one or more embodiments of the present disclosure;

FIG. 2A schematically depicts a side-view of a windshield of the vehicle depicted in FIG. 1 relative to an imaging system, according to one or more embodiments of the present disclosure;

FIG. 2B schematically depicts a top view of the windshield depicted in FIG. 2A relative to the imaging system, according to one or more embodiments of the present disclosure;

FIG. 3 schematically depicts a glass manufacturing apparatus, according to one or more embodiments of the present disclosure;

FIG. 4 schematically depicts illustrates a perspective cross-sectional view of the glass manufacturing apparatus along line 2-2 of FIG. 3, according to one or more embodiments of the present disclosure;

FIG. 5 schematically depicts a thickness sensor sensing a thickness of a first portion of a ribbon of glass-forming material after the first portion has been separated from a second portion of the ribbon, according to one or more embodiments of the present disclosure;

FIG. 6A is a flow diagram of a method of fabricating a glass article exhibiting low optical distortion, according to one or more embodiments of the present disclosure;

FIG. 6B is a flow diagram of a method of fabricating a glass article exhibiting low optical distortion, according to one or more embodiments of the present disclosure;

FIG. 7 is a plot of illustrative examples of a measured thickness profile and a target thickness profile for performing the method described in FIG. 6A, according to one or more embodiments of the present disclosure;

FIG. 8A is a plot of a 600 mm segment of a thickness profile of a glass article formed via the method described in FIG. 6A and an associated predicted optical distortion profile, according to one or more embodiments of the present disclosure; and

FIG. 8B is a plot of a 600 mm segment of a thickness profile of another glass article formed via the method described in FIG. 6A and an associated predicted optical distortion profile, according to one or more embodiments of the present disclosure;

FIGS. 9A and 9B are optical distortion maps of a glass article formed via the method described with respect to FIG. 6A, according to one or more embodiments of the present disclosure;

FIG. 10 depicts a perspective view of a glass substrate, according to one or more embodiments of the present disclosure.

### DETAILED DESCRIPTION

Reference will now be made in detail to embodiments of glass articles exhibiting ultra-low optical distortion and associated methods. Whenever possible, the same reference numerals will be used throughout the drawings to refer to the same or like parts. The glass articles described herein can generally be characterized as having major surfaces that exhibit minimal localized changes in thickness and curvature, such that glass articles comprise thickness profiles, measured along a line extending in a direction perpendicular to drawlines in the glass articles, with segments having relatively low levels of predicted optical distortion, approximated as 0.5 times a second derivative of the thickness profile along the line. The glass articles described herein can exhibit maximum predicted optical distortion values, representing optical distortion values at normal incidence, (absolute values in millidiopters) that are less than 20% of an average thickness of the glass article measured along the line (in mm). Glass articles with thicknesses of up to 6.0 mm with such segments are believed to be formable via the methods described herein, with such glass articles exhibiting maximum predicted optical distortion values that are less than or equal to 0.9 millidiopters when the thickness profiles are measured over a 500 mm line between the edges of the article. Such low levels of maximum optical distortion render the glass articles in accordance with the present disclosure suitable for various distortion-sensitive applications, such as protective windows for various sensors, automotive glazings, and other applications. Such low optical distortion values are not obtainable using certain existing forming methods (e.g., float-forming) without additional processing steps such as polishing or etching. It should be noted that the glass articles described herein may exhibit such favorable characteristics without necessarily having a uniform thickness. Thickness variations over relatively large distances (e.g., 300 mm or greater) can occur without necessarily preventing the glass articles from having the favorable optical performance described herein. Generally speaking, thickness variations having a relatively large spatial frequency are eliminated via the methods described herein to avoid localized lensing effects that can be magnified under various viewing conditions.

In aspects, the glass articles described herein can be formed using a down-draw process where laser energy is applied to glass-forming material in a viscous state in a spatially varying manner based on areas where it has been determined that the glass has a high likelihood of exhibiting relatively high level of optical distortion. The laser energy is applied to lower the viscosity of certain regions of the glass-forming material so that localized surface perturbations in the glass-forming material (e.g., areas of relatively high thickness slopes, areas of relatively high surface curvature) are abated. Care is taken in application of the laser energy to avoid introducing features into the glass that cause prohibitive levels of optical distortion. For example, in embodiments, a maximum change in laser power over a particular linear distance (e.g., 50 mm) in a direction parallel to thickness variations in the glass is applied to prevent areas of high slope and curvature.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

The term “disposed” is used herein to refer to a layer or sub-layer that is coated, deposited, formed, or otherwise provided onto a surface. The term disposed can include layers/sub-layers provided in direct contact with adjacent layers/sub-layers or layers/sub-layers separated by intervening material which may or may not form a layer.

As used herein, the term “drawline” is defined as a continuous strip of positive or negative vertical optical distortion, as measured using a commercially available distortion gauge, such as the SCREENSCAN-Faultfinder®, supplied by ISRA VISIION AG. Such drawlines result from stressing of glass-forming material during forming, and can generally be characterized as variations in a thickness of the glass article in a direction perpendicular to a direction of travel of molten glass material during the fabrication thereof.

As used herein, the term “vertical optical distortion” or “VOD” is a measure of the extent to which an article distorts an image transmitted through the glass article in a vertical direction (with vertical being defined as the gravitational direction). “Horizontal optical distortion” or “HOD” is a measure of the extent to which an article distorts an image transmitted the glass article in a direction perpendicular to the vertical direction (e.g., parallel to the ground on which a vehicle is disposed). Unless otherwise noted herein, measured optical distortion values are generated by reflecting Moiré illumination from an article and measuring the illumination with a commercially available optical distortion gauge. Unless otherwise noted herein, optical distortion measurements provided herein are for flat glass articles (planar sheets). Optical distortion measurements are reported herein for glass articles in an as-formed condition, without the major surfaces thereof being subjected to etching or polishing.

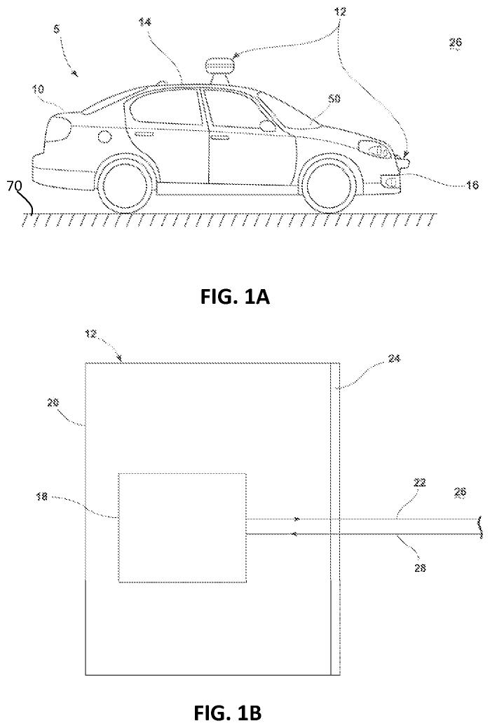

Referring now to FIG. 1, a vehicle 5 includes a body 10 and optionally one or more sensor systems 12 disposed on the body 10. The one or more sensor systems 12 can be disposed anywhere on or within the vehicle 5. For example, the one or more sensor systems 12 can be disposed on a roof 14 of the vehicle 5 and/or a forward portion 16 of the vehicle 5. With reference to FIG. 1B, in embodiments, the one or more sensor systems 12 include an electromagnetic radiation emitter and sensor 18, disposed in an enclosure 20. The particular sensor system depicted in FIG. 1B represents, for example, a light detection and ranging (“LiDAR”) system. Other sensing systems may employ components other than the depicted electromagnetic radiation emitter and sensor 18 (e.g., cameras, infrared light detectors, or other suitable sensing system). In the depicted example, the electromagnetic radiation emitter and sensor 18 emits electromagnetic radiation 22 having a wavelength or range of wavelengths. The emitted radiation 22 exits the enclosure 20 through a window 24 and, in some circumstances, reflects off of an object in an external environment 26 of the vehicle 5 and returns to the electromagnetic radiation emitter and sensor 18 as reflected radiation 28. The reflected radiation 28 again passes through the window 24 to reach the electromagnetic radiation emitter and sensor 18. The window 24 generally serves as a protective cover for the components inside of the enclosure 20. Since the window 24 is in the path of emitted radiation 22 and/or reflected radiation 28, any optical distortion present in the window may adversely affect the imaging performance of the sensor system 12. Accordingly, the glass articles described herein may be particularly well suited for use as a window 24.

Referring again to FIG. 1A, the vehicle 5 further includes an automotive glazing 50, i.e., window, disposed in an opening of the body 10. In embodiments, the automotive glazing 50 may form at least one of the sidelights, windshield, rear window, windows, and sunroofs in the vehicle 5. In some embodiments, the automotive glazing 50 may form an interior partition (not shown) within the interior of the vehicle 5, or may be disposed on an exterior surface of the vehicle 5 and form, e.g., an engine block cover, headlight cover, taillight cover, door panel cover, or pillar cover. As used herein, vehicle includes automobiles (an example of which is shown in FIG. 1A), rolling stock, locomotive, boats, ships, and airplanes, helicopters, drones, space craft, and the like. Further, while the present disclosure is framed in terms of a vehicle, the glass articles described herein may be used in a wide variety of applications (e.g., as cover glass in consumer electronics applications, in fabricating optical elements, in display components).

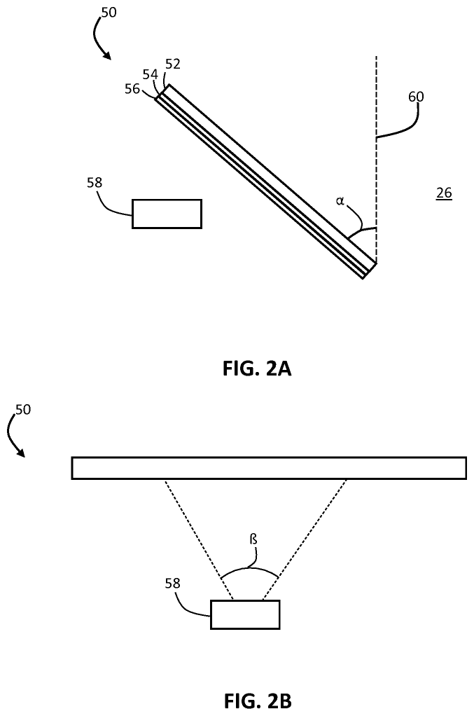

Referring now to FIG. 2A, a side view of the automotive glazing 50 is shown, according to an example embodiment. In the example embodiment, the automotive glazing 50 is a laminated glass article and comprises a first glass substrate 52, an interlayer 54, and a second glass substrate 56. Embodiments of the glass articles described herein are not limited to laminated articles and may comprise monolithic glass substrates. The first glass substrate 52 may generally face the external environment 26 when the automotive glazing 50 is installed in the vehicle 5, while the second glass substrate 56 may face the interior of the vehicle 5. The interlayer 54 may comprise a suitable polymeric material (e.g., polyvinyl butyral) to adhere the first and second glass substrates 52 and 56 to one another. In embodiments, the first glass substrate 52 differs from the second glass substrate 56 in at least one of thickness and composition to provide improved impact and acoustic performance. In embodiments, for example, the first glass substrate 52 comprises a first thickness that is at least 2.0 mm (e.g., at 3.0 mm, at least 3.5 mm, at least 3.8 mm, at least 4.0 mm, at least 5.0 mm) and the second glass substrate 56 comprises a second thickness that is less than 2.0 mm (e.g., greater than or equal to 0.0 mm and less than or equal to 1.5 mm, greater than or equal to 0.7 mm and less than or equal to 1.1 mm). Examples of glasses that may be used in the first glass substrate 52 or the second glass substrate 56 may include borosilicate glass compositions, aluminosilicate glass compositions alkali aluminosilicate glass compositions, alkali aluminoborosilicate glass compositions, and other suitable glass compositions.

In embodiments, one or both the first glass substrate 52 and the second glass substrate 56 particularly beneficially comprises one of the fusion-formable borosilicate glass compositions described in U.S. Provisional Patent Application No. 63/123,863, entitled “Fusion Formable Borosilicate Glass Composition and Articles Formed Therefrom” and filed on Dec. 10, 2020, U.S. Provisional Patent Application No. 63/183,271, entitled “Fusion Formable Borosilicate Glass Composition and Articles Formed Therefrom” and filed on May 3, 2021, U.S. Provisional Patent Application No. 63/183,292, entitled “Glass with Unique Fracture Behavior for Vehicle Windshield” and filed on May 3, 2021, U.S. patent application Ser. No. 17/363,266, entitled “glass with Unique Fracture Behavior for Vehicle Windshield” and filed on Jun. 30, 2021, International Patent Application No. PCT/US2021/061966, entitled “Glass with Unique Fracture Behavior for Vehicle Windshield” and filed on Dec. 6, 2021, and U.S. Provisional Patent Application No. 63/341,603, entitled “Glass with Unique Fracture Behavior for Vehicle Windshield,” filed on May 13, 2022, the contents of each of which are hereby incorporated by reference in their entireties. In embodiments, such a borosilicate glass composition comprises, in terms of constituent oxides, SiO₂, B₂O₃, Al₂O₃, one or more alkali metal oxides, and one or more divalent cation oxides selected from the group consisting of MgO, CaO, SrO, BaO, and ZnO. In embodiments the borosilicate glass composition comprises, for example, greater than or equal to 11 mol % and less than or equal to 16 mol % B₂O₃, greater than or equal to 2 mol % and less than or equal to 6 mol % Al₂O₃, and a total amount of Na₂O, K₂O, MgO, and CaO that is greater than or equal to 7.0 mol %. Concentrations in mole percent on an oxide basis of SiO₂, B₂O₃, the one or more alkali metal oxides, Al₂O₃, and the one or more alkaline earth metal oxides, satisfy the relationships: (R₂O+R′O)≥Al and 0.80<(1−[(2R₂O+2R′O)/(SiO₂+2Al₂O₃+2B₂O₃)])<0.93, where R₂O is the sum of the concentrations of the one or more alkali metal oxides and R′O is the sum of the concentrations of the one or more alkaline earth metal oxides. Such glasses may tend to exhibit a unique fracture behavior where ring cracks form around a region of contact between the glass and an impactor and prevent radial crack propagation. Such fusion-formed glasses may also exhibit superior chemical durability, scratch resistance, mechanical strength, and optical performance (e.g., from both an optical transmission and optical distortion perspective) than other glasses used in automotive glazing applications.

In embodiments, one or both of the first glass substrate 52 and the second glass substrate 56 is formed in a suitable down-draw process, such as those described herein. Such processes generally result in thickness variations extending in a particular direction (such that regions of constant thickness of the glass article extend parallel to the draw direction). These thickness variations are known as drawlines, with each drawline representing a contour of constant thickness generally extending in the draw direction. It has been common practice in the automotive industry to orient such drawlines vertically (e.g., in a direction perpendicular to the ground 70 depicted in FIG. 1A, represented by vertical axis 60) so that eyes of vehicle occupants tend to not move across the drawlines during driving, which tends to amplify the optical distortion caused thereby.

One trend in the automotive industry that tends to amplify the optical distortion effects of drawlines in the automotive industry is the relatively high angles relative to the vertical axis 60 that certain windshields are installed at. Particularly in battery electric vehicles, where aerodynamics are increasingly more important from an efficiency perspective due to increased weight, the automotive glazing 50 may be installed at a relatively high rake angle α relative to the vertical axis 60. Such greater inclination of the automotive glazing 50 may reduce drag. In embodiments, rake angle α is greater than or equal to 60° (e.g., greater than or equal to 65° or even greater than or equal to 70°). Such high rake angles magnify HOD and VOD induced by the automotive glazing 50, thereby rendering overall optical distortion performance for the article more important. Optical distortion measurements described herein taken at an “inclination angle” relative to the vertical direction refer to the rake angle α depicted in FIG. 2A.

FIG. 2A also depicts an image sensor 58 disposed on the interior side of the automotive glazing 50. The image sensor 58 may detect at least one aspect of the external environment 26 to facilitate providing feedback to at least one other component of the vehicle 5. For example, the image sensor 58 can be a camera configured to capture images and identify objects and movement paths thereof in the external environment 26 as a component of an ADAS. Another trend in the automotive industry is the use of higher resolution detection componentry (e.g., in terms of pixel per degree of field-of-view) in the image sensor 58. Such higher resolution componentry may render the image sensor 58 more sensitive to vertical optical distortion induced by the glazing 50.

Additionally, as shown in FIG. 2B, the image sensor 58 may be used with a relatively high field of view B in the horizontal direction (e.g., extending perpendicular to the vertical axis 60 and parallel to the ground 70). Field of views of ±200 (e.g., such that β=40°) or even ±25° (e.g., such that β=50°), or even greater may be employed to facilitate the image sensor 58 capturing relatively large portions of the external environment 26 in each image. As such, optical distortion imparted on light incident on the automotive glazing 50 at angles up to β/2 is relevant for various applications. Such horizontal angles of incidence on the automotive glazing 50 generally amplifies the optical effect of thickness variations extending in the horizontal direction (perpendicular to the drawlines in automotive glazing applications). Optical distortion measurements described herein taken at a “cross-viewing angle” relative to a horizontal direction refer to the angle β/2 depicted in FIG. 2B.

In view of the foregoing, the increasing utilization of high resolution sensors in vehicles generally lowers the acceptable levels of optical distortion that can be introduced by the automotive glazing 50. Moreover, if the automotive glazing 50 is installed at relatively high inclination relative to vertical, horizontal and vertical optical distortion are amplified. Use of wide field-of-view sensors also magnifies the importance of reducing vertical optical distortion introduced by the automotive glazing 50 as well. Given that the overall level of optical distortion introduced by the automotive glazing 50 is proportional to the optical distortion introduced by each of the first and second glass substrates 52 and 56, control of thickness variations in each of the first and second glass substrates 52 and 56 is important for providing desired levels of optical performance. Moreover, the optical distortion introduced by each of the first and second glass substrates 52 and 56 may generally be thought of as a combination of two factors: (a) local thickness variations inherent due to a sheet forming process; and (b) optical distortion introduced during the bending process for the first and second glass substrates 52 and 56 (while depicted as flat, each of the first and second glass substrates 52 and 56 may be bent about at least one axis of curvature via any known process such as gravity bending or press bending, such that, in some embodiments, the first and second glass substrates 52 and 56 are bent about two distinct axes of curvature such that the first and second glass substrates 52 and 56 are convexly curved). The forming process described herein beneficially reduces localized curvature resulting from the forming process, thereby lowering the overall optical distortion levels that are achievable. Glass articles described herein may exhibit maximum (99.9%) VOD values that are less than 16 millidiopters (preferably greater than or equal to 7 millidiopters and less than or equal to 12 millidiopters, or even more preferably greater than or equal to 6 millidiopters and less than or equal to 10 millidiopters, or even more preferably greater than or equal to 6 millidiopters and less than or equal to 9 millidiopters). The glass articles described herein can also exhibit maximum (99.9%) HOD values that less than or equal to 60 millidiopters (preferably greater than or equal to 6 millidiopters and less than or equal to 50 millidiopters, or even more preferably greater than or equal to 6 millidiopters and less than or equal to 12 millidiopters, or even more preferably greater than or equal to 6 millidiopters and less than or equal to 10 millidiopters, or even more preferably greater than or equal to 6 millidiopters and less than or equal to 9 millidiopters), respectively, when measured at a 60° inclination angle and a 20° cross-viewing angle. Such values are far lower than those associated with existing glasses used in automotive applications. The relatively low levels of both horizontal and vertical optical distortions exhibited by the glass articles described herein (such that a sum of the HOD and VOD values is less than or equal to 80 millidiopters or even less than or equal to 50 millidiopters, or even less than or equal to 20 millidiopters, in some embodiments) beneficially facilitates the utilization of high resolution sensing systems at wide viewing angles.

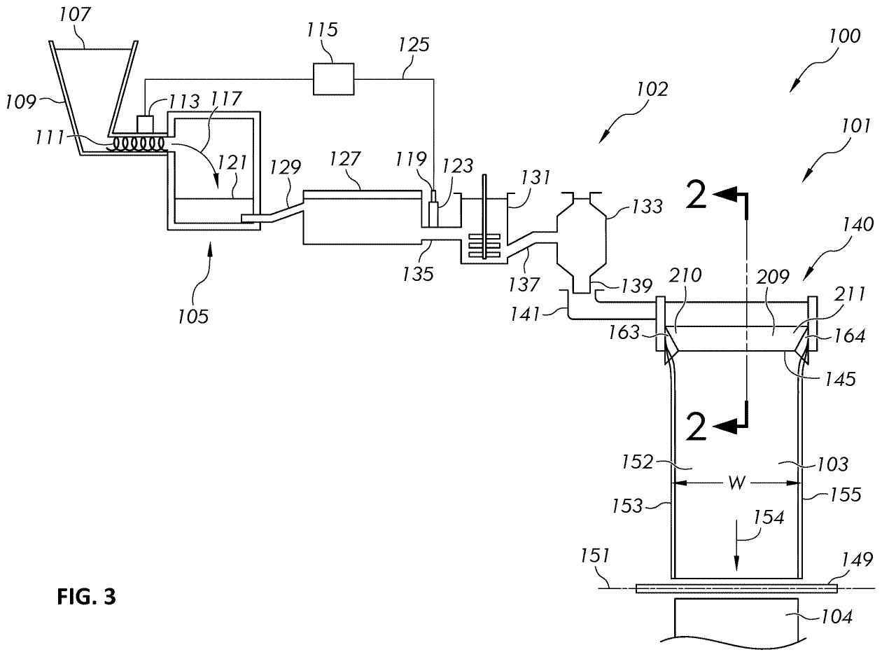

Referring now to FIG. 3 a glass manufacturing apparatus 100 is shown, according to an example embodiment. Glass manufacturing apparatus 100 can be used to form sheets of glass material exhibiting relatively low amounts of optical distortion, as described herein. Glass sheets formed via the glass manufacturing apparatus 100 may be used to form various glass articles, such as the first glass substrate 52 or the second glass substrate 56 described herein, and other glass articles.

In the depicted embodiment, the glass manufacturing apparatus 100 comprises a glass melting and delivery apparatus 102 and a forming apparatus 101 comprising a forming vessel 140 designed to produce a ribbon of glass-forming material 103 from a quantity of molten material 121. In some embodiments, the ribbon of glass-forming material 103 can comprise a central portion 152 positioned between opposite edge portions (e.g., edge beads) formed along a first outer edge 153 and a second outer edge 155 of the ribbon of glass-forming material 103, wherein a thickness of the edge portions can be greater than a thickness of the central portion. Additionally, in some embodiments, a separated glass ribbon 104 can be separated from the ribbon of glass-forming material 103 along a separation path 151 by a glass separator 149 (e.g., scribe, score wheel, diamond tip, laser, etc.).

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery chamber 133 that can be located downstream from the mixing chamber 131. In some embodiments, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In some embodiments, molten material 121 can be gravity fed from the mixing chamber 131 to the delivery chamber 133 by way of the third connecting conduit 137. For example, in some embodiments, gravity can drive the molten material 121 through an interior pathway of the third connecting conduit 137 from the mixing chamber 131 to the delivery chamber 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure, for example, a forming vessel with a wedge for fusion drawing the glass ribbon, a forming vessel with a slot to slot draw the glass ribbon, or a forming vessel provided with press rolls to press roll the glass ribbon from the forming vessel. In some embodiments, the forming apparatus 101 can comprise a sheet redraw, for example, with the forming apparatus 101 as part of a redraw process. For example, the glass ribbon 104, which can comprise a thickness, may be heated up and redrawn to achieve a thinner glass ribbon 104 comprising a smaller thickness. By way of illustration, the forming vessel 140 shown and disclosed below can be provided to fusion draw molten material 121 off a bottom edge, defined as a root 145, of a forming wedge 209 to produce the ribbon of glass-forming material 103. For example, in some embodiments, the molten material 121 can be delivered from the inlet conduit 141 to the forming vessel 140. The molten material 121 can then be formed into the ribbon of glass-forming material 103 based, in part, on the structure of the forming vessel 140. For example, as shown, the molten material 121 can be drawn off the bottom edge (e.g., root 145) of the forming vessel 140 along a draw path extending in a travel direction 154 of the glass manufacturing apparatus 100. In some embodiments, edge directors 163, 164 can direct the molten material 121 off the forming vessel 140 and define, in part, a width “W” of the ribbon of glass-forming material 103. In some embodiments, the width “W” of the ribbon of glass-forming material 103 extends between the first outer edge 153 of the ribbon of glass-forming material 103 and the second outer edge 155 of the ribbon of glass-forming material 103.

In some embodiments, the width “W” of the ribbon of glass-forming material 103, which extends between the first outer edge 153 of the ribbon of glass-forming material 103 and the second outer edge 155 of the ribbon of glass-forming material 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in further embodiments. For example, in some embodiments, the width “W” of the ribbon of glass-forming material 103 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

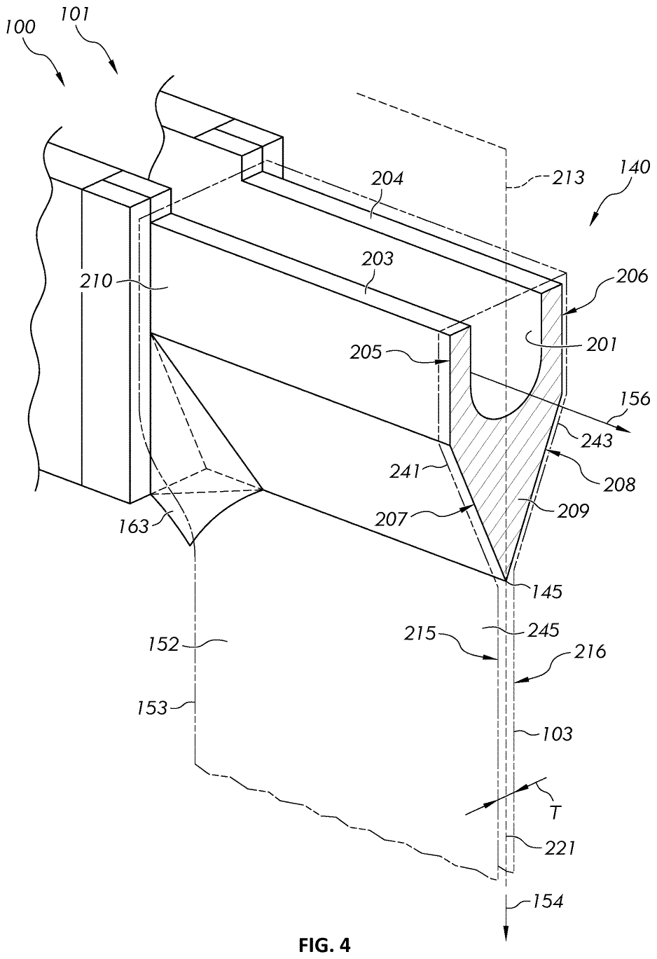

FIG. 4 shows a cross-sectional perspective view of the forming apparatus 101 (e.g., forming vessel 140) along line 2-2 of FIG. 3. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 3) of the forming wedge 209. The pair of downwardly inclined converging surface portions 207, 208 of the forming wedge 209 can converge along the travel direction 154 to intersect along the root 145 of the forming vessel 140. The root 145 defines a bottom of the forming wedge 209 at which the downwardly inclined converging surface portions 207, 208 intersect to form a point. A draw plane 213 of the glass manufacturing apparatus 100 can extend through the root 145 along the travel direction 154. In some embodiments, the ribbon of glass-forming material 103 can be drawn in the travel direction 154 along the draw plane 213. As shown, the draw plane 213 can bisect the forming wedge 209 through the root 145 although, in some embodiments, the draw plane 213 can extend at other orientations relative to the root 145. In some embodiments, methods of manufacturing a glass ribbon can comprise moving the ribbon of glass-forming material 103 along a travel path 221 in the travel direction 154, wherein the travel path 221 may be co-planar with the draw plane 213.

Additionally, in some embodiments, the molten material 121 can flow in a direction 156 into and along the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. For example, methods of manufacturing a glass ribbon can comprise flowing a first stream 241 of glass-forming material over a first weir 203 of the forming wedge 209 and flowing a second stream 243 of glass-forming material over a second weir 204 of the forming wedge 209. The first stream 241 of glass-forming material and the second stream 243 of glass-forming material can flow along the downwardly inclined converging surface portions 207, 208 of the forming wedge 209 to be drawn off the root 145 of the forming vessel 140. In some embodiments, methods of manufacturing a glass ribbon can comprise fusing the first stream 241 of glass-forming material and the second stream 243 of glass-forming material to form a fused ribbon 245. For example, the first stream 241 and the second stream 243 can converge and fuse at the root 145. In some embodiments, the fused ribbon 245 can be drawn off the root 145 in the draw plane 213 along the travel direction 154. In some embodiments, the ribbon of glass-forming material 103 can comprise the first stream 241 of glass-forming material and the second stream 243 of glass-forming material upstream of the root 145 relative to the travel direction 154 prior to fusing and may comprise the fused ribbon 245 that has been drawn off the root 145 downstream from the forming wedge 209 relative to the travel direction 154. The ribbon of glass-forming material 103 can comprise at least one state of material based on a vertical location of the ribbon of glass-forming material 103. For example, at one location, the ribbon of glass-forming material 103 can comprise the viscous molten material 121, and at another location, the ribbon of glass-forming material 103 can comprise an amorphous solid in a glassy state (e.g., a glass ribbon).

The ribbon of glass-forming material 103 comprises a first major surface 215 and a second major surface 216 facing opposite directions and defining a thickness “T” (e.g., average thickness) of the ribbon of glass-forming material 103 along an axis normal to one or both of the first major surface 215 or the second major surface 216. In some embodiments, the thickness “T” of the ribbon of glass-forming material 103 can be less than or equal to about 6 millimeters (mm), less than or equal to 5 millimeters, less than or equal to 4 millimeters, less than or equal to 3 mm, less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T” of the ribbon of glass-forming material 103 can be within a range from about 20 micrometers to about 6 mm. As described herein, one aspect of the present disclosure is that the ribbon of glass-forming material 103 can have relatively high thicknesses in some embodiments, such as greater than or equal to 2.0 mm, greater than or equal to 3.0 mm, or even greater than or equal to 3.5 mm, while also exhibiting relatively low levels of optical distortion. Such thicknesses may facilitate formation of glass sheets for use as the first glass substrate 52 of the automotive glazing 50 (see FIG. 2A). In addition, the ribbon of glass-forming material 103 can comprise a variety of compositions, for example, borosilicate glass, alumino-borosilicate glass, alkali-containing glass, or alkali-free glass, alkali aluminosilicate glass, alkaline earth aluminosilicate glass, soda-lime glass, etc.

In some embodiments, the glass separator 149 (see FIG. 3) can separate the glass ribbon 104 from the ribbon of glass-forming material 103 along the separation path 151 to provide a plurality of separated glass ribbons 104 (i.e., a plurality of sheets of glass). According to other embodiments, a longer portion of the glass ribbon 104 may be coiled onto a storage roll. The separated glass ribbon can then be processed into a desired application, e.g., an automotive application, a display application. For example, the separated glass ribbon can be used in automotive applications (e.g., as one of the first and second glass substrates 52 and 56, as the window 24 (see FIG. 2B), as a cover glass for an interior display), consumer electronics (e.g., as a cover glass or protective cover), and a wide range of display applications, comprising liquid crystal displays (LCDs), electrophoretic displays (EPD), organic light emitting diode displays (OLEDs), plasma display panels (PDPs), touch sensors, photovoltaics, and other electronic displays.

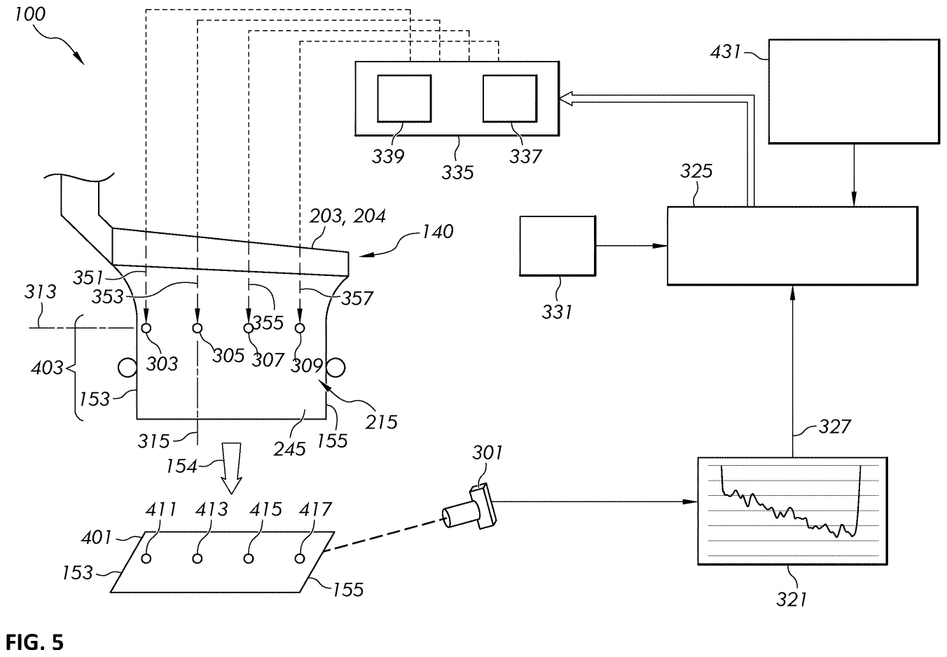

FIG. 5 illustrates a schematic view of the forming vessel 140. In some embodiments, the glass manufacturing apparatus 100 can comprise a thickness sensor 301 that can measure the thickness (e.g., thickness “T” illustrated in FIG. 4) of the ribbon of glass-forming material 103. For example, the thickness may be measured between the first major surface 215 and the second major surface 216 of the ribbon of glass-forming material 103 (e.g., perpendicular to the width “W” of the ribbon of glass-forming material 103 extending between the first outer edge 153 and the second outer edge 155 illustrated in FIG. 3). In some embodiments, the thickness sensor 301 can sense a thickness of the ribbon of glass-forming material 103 at a bottom of the forming vessel 140, for example, downstream from the root 145 of the forming vessel 140 relative to the travel direction 154 (e.g., upstream of the separator 149 depicted in FIG. 3) as the ribbon of glass forming material is travelling in the travel direction 154. In the depicted embodiment, the thickness of the ribbon of glass-forming material 103 can be sensed after a first ribbon portion 401 has been separated from a second ribbon portion 403. For example, in some embodiments, methods of manufacturing a glass ribbon can comprise separating the first ribbon portion 401 of the ribbon of glass-forming material 103 from the second ribbon portion 403 of the ribbon of glass-forming material 103 prior to sensing a thickness of the first ribbon portion 401. As the ribbon of glass-forming material 103 moves in the travel direction 154, the first ribbon portion 401 can be separated from the second ribbon portion 403, for example, by the glass separator 149 of FIG. 3. In some embodiments, the first ribbon portion 401 can be transported to a remote location following the separation, for example, to a location where the first ribbon portion 401 can be inspected and a thickness can be measured. In some embodiments, the thickness sensor 301 can comprise a laser-based thickness measurement device.

In some embodiments, while not depicted in FIG. 3, the thickness sensor 301 can sense the thickness of the ribbon of glass-forming material 103 at one or more locations, for example, at a first location 303, a second location 305, a third location 307, a fourth location 309, etc. While reference is made herein to the first, second, third, and fourth locations 303, 305, 307, and 309, it should be understood that the thickness sensor 301 can sense the thickness at any number of locations across the width of the ribbon of glass forming material 103 (e.g., the thickness sensor 301 can perform a thickness measurement over every 5 mm interval, every 2 mm interval, every 1 mm interval, or even smaller intervals over the entire width) In some embodiments, methods of manufacturing a glass ribbon can comprise sensing the thickness of the ribbon of glass-forming material 103 at the plurality of locations (e.g., the first location 303, the second location 305, the third location 307, the fourth location 309, etc.) of the ribbon of glass-forming material 103. Sensing the thickness of the ribbon of glass-forming material 103 may occur at the plurality of locations spaced apart along a first axis 313 that may be substantially perpendicular to the travel direction 154. For example, the first axis 313 may extend across the ribbon of glass-forming material 103 (e.g., between the first outer edge 153 and the second outer edge 155) along a direction that may be substantially parallel to the first major surface 215 and/or the second major surface 216 of the ribbon of glass-forming material 103. In some embodiments, a distance separating the first location 303 from the first outer edge 153 may be less than a distance separating the second location 305, the third location 307, and/or the fourth location 309 from the first outer edge 153. In some embodiments, a distance separating the fourth location 309 from the second outer edge 155 may be less than a distance separating the first location 303, the second location 305, and/or the third location 307 from the second outer edge 155. In some embodiments, the second location 305 and the third location 307 may be located between the first location 303 and the fourth location 309.

The glass manufacturing apparatus 100 is not limited to sensing the thickness of the ribbon of glass-forming material 103 along a single axis, for example, the first axis 313. Rather, in some embodiments, the thickness sensor 301 and/or an additional thickness sensor can sense the thickness of the ribbon of glass-forming material 103 along one or more axes that may be angled relative to the first axis 313, for example, along a second axis 315 that may be substantially perpendicular to the first axis 313 and substantially parallel to the travel direction 154. The second axis 315 may intersect the second location 305. In some embodiments, the thickness sensor 301 and/or an additional thickness sensor can sense the thickness of the ribbon of glass-forming material 103 along one or more axes that may be substantially parallel to the first axis 313 and/or to the second axis 315.

In some embodiments, the thickness sensor 301 can generate a thickness profile 321 corresponding to the thicknesses sensed by the thickness sensor 301 at the plurality of locations, for example, the first location 303, the second location 305, the third location 307, and the fourth location 309. The thickness sensor 301 can periodically and/or continuously sense the thickness of the ribbon of glass-forming material 103. For example, in some embodiments, the thickness sensor 301 can continuously sense the thickness at the plurality of locations (e.g., without interruptions or gaps), such that the thickness sensor 301 can generate an updated thickness profile 321 corresponding to a real-time thickness of the ribbon of glass-forming material 103. The real-time thickness of the ribbon of glass-forming material 103 can represent the instantaneous thickness at the time that the ribbon of glass-forming material 103 is measured, whereupon the thickness of the ribbon of glass-forming material 103 may be immediately transmitted to a device (e.g., a control device 325) for processing. In some embodiments, the thickness sensor 301 can periodically sense the thickness at the plurality of locations, for example, by sensing the thickness of the ribbon of glass-forming material 103, followed by waiting a predetermined period of time without sensing the thickness, followed by sensing the thickness again, etc. The thickness sensor 301 can therefore generate an updated thickness profile 321 that may not correspond to the real-time thickness at the plurality of locations. In some embodiments, the thickness sensor 301 can sense the thickness at a static location relative to the forming vessel 140. For example, in some embodiments, the thickness sensor 301 can sense the thickness at the plurality of locations 303, 305, 307, or 309, wherein the first axis 313 and, thus, the plurality of locations 303, 305, 307, or 309, may be located a static and non-changing distance from the root 145.

In some embodiments, the glass manufacturing apparatus 100 can comprise the control device 325 that may be coupled to the thickness sensor 301. The control device 325 can comprise, for example, a computer, a computer-like device, a programmable logic controller, etc. In some embodiments, the control device 325 may be configured to (e.g., programmed to, encoded to, designed to, and/or made to) effectuate a change in the thickness of the ribbon of glass-forming material 103 based on the thickness sensed by the thickness sensor 301. For example, the thickness sensor 301 can be in communication with the control device 325 by way of a communication line 327 (e.g., wired, wireless, etc.). The thickness profile 321 can be transmitted from the thickness sensor 301 to the control device 325 through the communication line 327. In some embodiments, a target thickness profile 331 can be transmitted to the control device 325. The target thickness profile 331 can comprise an operating range of target thicknesses of the ribbon of glass-forming material 103. For example, the target thickness profile 331 can comprise a first target thickness at the first location 303, a second target thickness at the second location 305, a third target thickness at the third location 307, and a fourth target thickness at the fourth location 309.

In some embodiments, the glass manufacturing apparatus 100 can comprise a laser apparatus 335 that can emit a laser beam to increase a temperature and decrease a viscosity of a portion of the ribbon of glass-forming material 103 in a viscous state, thereby altering the thickness at the portion of the ribbon of glass-forming material 103 that is impinged by the laser beam, as well as a heat-affected zone around the laser beam. In some embodiments, the laser apparatus 335 can comprise a laser generator 337. The laser generator 337 can generate and emit the laser beam. In some embodiments, the laser generator 337 can comprise a high-intensity infrared laser generator, for example, a carbon dioxide (CO₂) laser generator. The laser generator 337 can produce a laser beam that comprises a wavelength and power that are sufficient to increase the temperature and decrease the viscosity of the portion of the ribbon of glass-forming material 103 that is impinged by the laser beam. In some embodiments, to control a direction at which the laser beam from the laser generator 337 is oriented, the laser apparatus 335 can comprise a beam-directing apparatus 339. The beam-directing apparatus 339 can comprise a reflecting surface, for example, a mirror. The beam-directing apparatus 339 can be coupled to a movement apparatus that can move the beam-directing apparatus 339, for example, by rotating the beam-directing apparatus 339 and/or translating the beam-directing apparatus 339.

The beam-directing apparatus 339 can receive the laser beam from the laser generator 337 and direct (e.g., reflect when the beam-directing apparatus 339 comprises a mirror) the laser beam toward the ribbon of glass-forming material 103. In embodiments, the beam-directing apparatus can scan the laser beam in a continuous (e.g., linear) pattern across the ribbon of glass-forming material 103. For example, in some embodiments, the beam-directing apparatus 339 can direct the laser beam toward one or more of the first location 303, the second location 305, the third location 307, and/or the fourth location 309. In some embodiments, the beam-directing apparatus 339 can direct a first laser beam 351 toward the first location 303, in which the first laser beam 351 may impinge upon the ribbon of glass-forming material 103 at a location below the root 145 of the forming vessel 140. In some embodiments, the beam-directing apparatus 339 can direct a second laser beam 353 toward the second location 305, in which the second laser beam 353 may impinge upon the ribbon of glass-forming material 103 at a location below the root 145 of the forming vessel 140. In some embodiments, the beam-directing apparatus 339 can direct a third laser beam 355 toward the third location 307, in which the third laser beam 355 may impinge upon the ribbon of glass-forming material 103 at a location below the root 145 of the forming vessel 140. In some embodiments, the beam-directing apparatus 339 can direct a fourth laser beam 357 toward the fourth location 309, in which the fourth laser beam 357 may impinge upon the ribbon of glass-forming material 103 at a location below the root 145 of the forming vessel 140. In embodiments, the first, second, third, and fourth laser beams 351, 353, 355, and 357 represent a single laser beam at different points in time as the laser beam is scanned across the ribbon via the beam-directing apparatus 339. In some embodiments, the beam-directing apparatus 339 can be moved based on control instructions that may be provided from the control device 325 to the laser apparatus 335, wherein the control instructions may instruct the beam-directing apparatus 339 to direct one or more of the laser beams 351, 353, 355, or 357 to a specific location.

In some embodiments, the control device 325 can compare the thickness profile 321 to the target thickness profile 331 to determine whether a corresponding thickness at one of the locations 303, 305, 307, or 309 exceeds a target thickness of the target thickness profile 331. For example, the control device 325 can receive the thickness profile 321, which may comprise the thicknesses of the ribbon of glass-forming material 103 at the first location 303, the second location 305, the third location 307, and the fourth location 309 as measured by the thickness sensor 301. For example, the control device 325 can compare the thickness at the locations 303, 305, 307, and/or 309 to the target thickness profile 331, for example, a target thickness of the locations 303, 305, 307, and/or 309, respectively. In some embodiments, methods of manufacturing a glass ribbon can comprise identifying a location of the plurality of locations 303, 305, 307, and/or 309 in which a corresponding thickness at the location exceeds a target thickness (e.g., from the target thickness profile 331). The control device 325 can determine the thickness difference between a measured thickness at one of the locations 303, 305, 307, or 309 and a target thickness at that location 303, 305, 307, or 309. In addition, as described relative to FIG. 5, the control device 325 can determine the appropriate laser power of the laser beam 351, 353, 355, 357 to cause a decrease in viscosity at the location and attain the target thickness at the location.

The control device 325 can transmit instructions comprising the appropriate laser power and the location to the laser apparatus 335. In some embodiments, methods of manufacturing a glass ribbon can comprise directing the laser beams 351, 353, 355, 357, toward the ribbon of glass-forming material 103 to decrease the viscosity at the location and attain the target thickness at the location. For example, in some embodiments, a measured thickness at the first location 303 of the ribbon of glass-forming material 103 may exceed the target thickness at the first location 303. The control device 325 can determine the difference between the measured thickness and the target thickness at the first location 303 and correlate a rate of thickness change to a laser power. In some embodiments, the rate of thickness change and the laser power can be provided to the control device 325 and may be based on actual observed impacts of thickness changes based on a particular laser power. In some embodiments, the rate of thickness change and the laser power provided to the control device 325 can be based on a mathematical model. In some embodiments, the model can be updated with actual observed impacts based on different laser powers. The control device 325 can cause the laser generator 337 to direct the first laser beam 351 toward the first location 303 at the laser power. In response, a viscosity at the first location 303 may decrease which can cause the thickness at the first location 303 to decrease until the target thickness is attained at the first location 303.

Following the separation, methods of manufacturing a glass ribbon can comprise sensing a thickness at a plurality of locations of the first ribbon portion 401. For example, the thickness sensor 301 can sense the thickness of the first ribbon portion 401 at a first location 411, a second location 413, a third location 415, and a fourth location 417 of the first ribbon portion 401, although in further embodiments, the thickness can be sensed in more than four locations while in still further embodiments, the thickness can be sensed in fewer than four locations. In some embodiments, sensing the thickness of the ribbon of glass-forming material 103 can occur in the first ribbon portion 401 of the ribbon of glass-forming material 103 after separating the first ribbon portion 401 from the second ribbon portion 403 of the ribbon of glass-forming material 103. In some embodiments, the thickness of the first ribbon portion 401 can be sensed immediately following the separation of the first ribbon portion 401 from the second ribbon portion 403, such that a time delay between the separation of the first ribbon portion 401 and the sensing of the thickness of the first ribbon portion 401 may be short. In some embodiments, the time delay may be longer, for example, when the thickness of the first ribbon portion 401 is not sensed immediately following the separation, but, rather, after a period of time has passed following the separation. For example, a time delay may result from transporting the first ribbon portion 401 from the location where the first ribbon portion 401 is separated to the remote location where the first ribbon portion 401 can be inspected and a thickness can be measured.

In some embodiments, a position of the first location 411, the second location 413, the third location 415, and/or the fourth location 417 relative to the first outer edge 153 and the second outer edge 155 of the first ribbon portion 401 can correspond to a position of the first location 303, the second location 305, the third location 307, and/or the fourth location 309, respectively, relative to the first outer edge 153 and the second outer edge 155 of the second ribbon portion 403. For example, the first location 411 can be spaced a first distance from the first outer edge 153 of the first ribbon portion 401, and the first location 303 can be spaced the first distance from the first outer edge 153 of the second ribbon portion 403. In some embodiments, the fourth location 417 can be spaced a second distance from the second outer edge 155 of the first ribbon portion 401, and the fourth location 309 can be spaced the second distance from the second outer edge 155 of the second ribbon portion 403. In some embodiments, a distance separating the plurality of locations 411, 413, 415, or 417 of the first ribbon portion 401 can match a distance separating the plurality of locations 303, 305, 307, or 309 of the second ribbon portion 403. Accordingly, a thickness at the plurality of locations 411, 413, 415, or 417 of the first ribbon portion 401 can be altered by impinging the laser beam 351, 353, 355, or 357 at the plurality of locations 303, 305, 307, or 309 of the second ribbon portion 403 and/or by impinging the laser beam 361, 363, 365, or 367 at the first stream 241 flowing over the first weir 203 and/or the second stream 243 flowing over the second weir 204.

In some embodiments, methods of manufacturing a glass ribbon can comprise identifying a first location of the plurality of locations 411, 413, 415, or 417 in which a corresponding thickness at the first location 303 exceeds a target thickness. The thickness sensor 301 can sense the thickness of the plurality of locations 411, 413, 415, or 417 of the first ribbon portion 401, and generate the thickness profile 321. In some embodiments, the control device 325 can compare the measured thicknesses of the thickness profile 321 with the target thickness profile 331 to identify whether any of the measured thicknesses of the locations 411, 413, 415, or 417 exceed a target thickness. In addition, in some embodiments, the control device 325 can calculate the time delay between the separating of the first ribbon portion 401 (e.g., from the second ribbon portion 403) and the sensing of the thickness. For example, a period of time may pass between separating the first ribbon portion 401 and sensing the thickness with the thickness sensor 301 at the locations 411, 413, 415, or 417, wherein the period of time may comprise, in part, the time it takes to transport the first ribbon portion 401 to a remote location. While the preceding example describes using thickness profile measurements to control laser power, it is also envisioned that optical distortion can be measured instead of or in addition to thickness profile and that such optical distortion measurements can be used to control laser power.

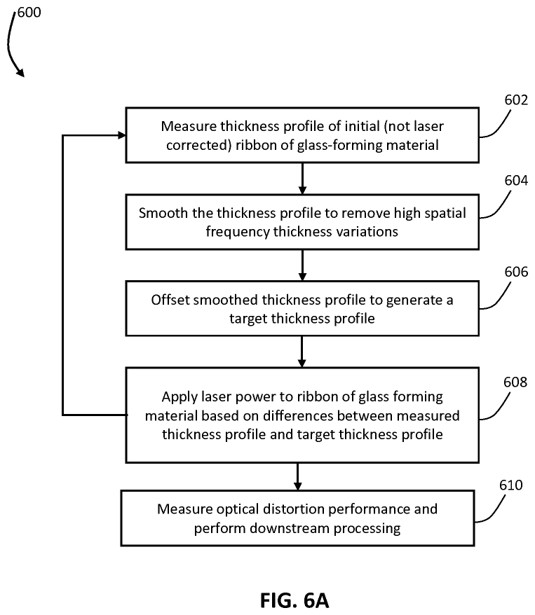

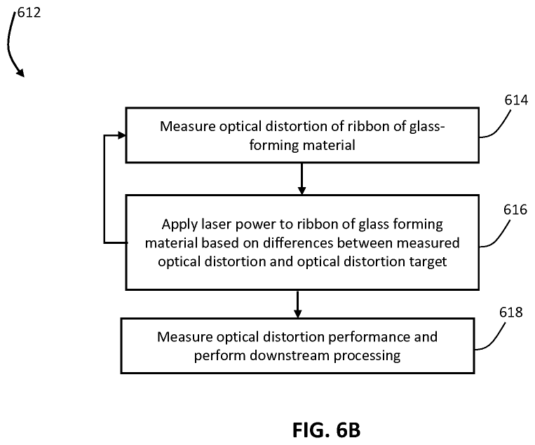

Referring now to FIG. 6A, a flow diagram of a method 600 for fabricating a glass sheet with a desired thickness profile is shown, according to an example embodiment. Method 600 may be performed via the glass manufacturing apparatus 100 described herein with respect to FIGS. 3-5 to form glass sheets having favorable optical performance for various applications. Reference will be made to various components depicted in FIGS. 3-5 to aid in describing the method 600. The method 600 may be formed after the batch material 107 has been melted and delivered to the forming vessel 140 to form the ribbon of glass-forming material 103. At block 602, the thickness profile 321 of the ribbon of glass-forming material 103 is measured. For example, in embodiments, the thickness sensor 301 can measure a thickness of the first ribbon portion 401 at the first, second, third, and fourth locations 411, 413, 415, and 417 to generate the thickness profile 321. In embodiments, the thickness profile 321 can comprise typically at least one measurement per 5 mm increment in the direction of the width W to ensure accuracy. While only four locations are depicted in FIG. 5 to be detected by the thickness sensor 301, it should be understood that typically at least 100 (e.g., at least 200, at least 300, at least 400, at least 500, at least 1000) thickness measurements may be taken to generate the thickness profile 321.

At block 604, the thickness profile 321 is smoothed to remove high spatial frequency thickness variations therein. In an as-measured state, the thickness profile 321 may include measurement noise that is not physically present in the ribbon of glass-forming material 103. Such smoothing operations remove such noise to generate a smoothed thickness profile actually representative of the ribbon. In embodiments, such artifacts may be removed for example by calculating a moving window average over a relatively small width interval (e.g., less than or equal to 50 mm, less than or equal to 30 mm, less than or equal to 20, or less than or equal to 10 mm). For example, the control device 325 (e.g., via executing instructions associated with a suitable control algorithm stored in memory therein) can compute such a moving average and generate a smoothed thickness profile. Such a smoothing operation can also be performed in the spatial frequency domain with an appropriate Fourier filter (e.g., a low-pass filter).

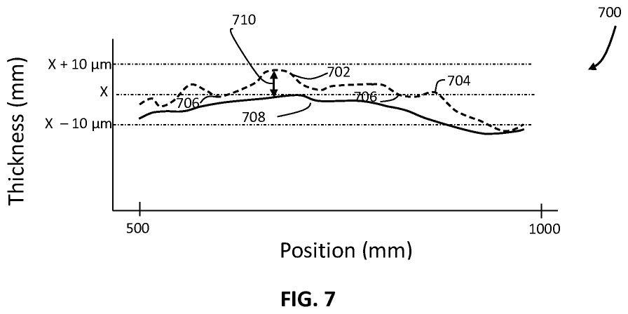

In embodiments, smoothing the thickness profile 321 has the intent of not removing high frequency thickness variations therein that are actually believed to be present in the ribbon of glass-forming material 103 (rather than those associated with measurement signal noise) that are also below the spatial resolution of the laser. Such high frequency thickness variations (e.g., drawlines) are desired to be mitigated to improve the optical distortion performance of the glass article. Referring to FIG. 7, a plot 700 that includes an illustrative example smoothed thickness profile 702 is shown. Smoothed thickness profile 702 is an example of the thickness profile 321 described herein, smoothed with a 10 mm moving average. The smoothed thickness profile 702 comprises localized thickness variations that general form local convexities 704 and local concavities 706. Local convexities 704 and local concavities 706 generally result from deviations in the first and second major surfaces 215 and 216 (see FIG. 4) from a perfectly planar shape. Local convexities 704 and local concavities 706 are drawlines formed from the stretching of the ribbon of glass-forming material 103. Such drawlines are believed to be sources of optical distortion.

If one takes the smoothed thickness profile 702 and calculates the slope and curvature thereof, an approximation of the radius of curvature of the ribbon can be calculated from the smoothed thickness profile 702 as:

$$R = \frac{{( 1 + {y}^{′2} )}^{3 / 2}}{{y}^{″}} \qquad ( 1 )$$

where y represents the measured thickness at a particular point x (along the width direction), y′ is dy/dx, and y″ is d²y/dx². It is believed that R is correlated with optical distortion at that point in the thickness profile. If one uses the thin lens approximation, and assumes that the thickness is equally divided as changes to the first and second major surfaces 215 and 216, the lensing power associated with local convexities 704 and local concavities 706 can be approximated as (n−1)/R, with n being the refractive index of the glass. It has been observed that the second derivative of the thickness profile tends to be substantially greater than the first derivative. Accordingly, the total optical distortions introduced by local convexities 704 and local concavities 706 is well approximated as proportional to the second derivative of the smoothed thickness profile 702.

In view of the foregoing, to generate a target thickness profile 331 that successfully abates local convexities 704 and local concavities 706 and effectively reduces observable optical distortion, further smoothing operations are conducted on the smoothed thickness profile 702. Such smoothing operations reduce localized areas where curvature of the ribbon of glass-forming material 103 exceeds a predetermined threshold. It has been found that utilizing a moving average over a relatively large width window (e.g., approximately 50 mm, 75 mm, 100 mm, 125 mm, 150 mm, 300 mm, 400 mm, or 500 mm) serves to illuminate such areas of localized curvature by smoothing the measured thickness profile 321. In embodiments, rather than a moving average, other smoothing functions can be utilized (e.g., Fourier filters, a second derivative of the measured thickness profile 321 could be averaged and subsequently integrated to provide a target thickness profile). Such processing may be performed to generate a zero phase shifted target thickness profile (not depicted). The zero phase shifted target profile still includes thickness variations, just over significant distances or of small magnitude so the radius of curvature is limited to avoid appreciable levels of optical distortion.

Referring again to FIG. 6A, at block 606, the zero phase shifted profile is offset to generate a target thickness profile 331. FIG. 7 depicts a target thickness profile 708 generated based on the previously described zero phase shifted target profile obtained from the smoothed thickness profile 702. To generate the target thickness profile 708, the zero phase shifted target thickness profile can be offset by a fixed thickness amount. Such offsetting is needed because the smoothed thickness profile 702 may include portions that are beneath (less than) the zero phase shifted target profile. As described herein, the application of laser energy heats the glass and reduces the viscosity thereof so as to locally reduce the thickness of a target region. As such, if a purely smoothed, and thus zero phase shifted, target thickness profile were used as a target, no laser energy would be applied to certain areas (about half) and significant curvature would still be observed in the glass article (predominately as local concavities 706). Accordingly, in embodiments, the zero phase shifted target thickness profile is offset such that the target thickness profile 708 is less than or equal to the smoothed thickness profile 702 throughout the entirety of the width W (e.g., the zero phase shifted target thickness profile can be offset by at least a maximum amount that the smoothed thickness profile 702 is less than the zero phase shifted target thickness profile). This way, laser energy can be applied to an entirety of the width W (if needed) to correct localized regions of curvature throughout and reduce a maximum optical distortion exhibited by the glass article. Laser energy may be applied over any suitable portion of the ribbon of glass-forming material 103 desired to have improved optical distortion performance.

At block 608, laser power is applied to the ribbon of glass-forming material 103 based on differences between the thickness profile 321 and the target thickness profile 331. At each of the locations 303, 305, 307, and 309, for example, the control device 325 may compute a difference 710 between the smoothed thickness profile 702 (see FIG. 7) and target thickness profile 708 and determine a laser power needed based on the magnitude of the difference. The needed laser power may be determined based on a predictive model of induced thickness change, as described herein. In embodiments, the difference between the thickness profiles is multiplied by a power scaling factor that can be greater than or equal to 1 W/μm and less than or equal to 10 W/μm to determine the laser power to be applied using a CO₂ laser source to that particular location. Such a power scaling factor is dependent on the type of laser used. In embodiments, the power scaling factor can be determined based on the composition of the ribbon of glass-forming material 103 and other laser operating parameters (e.g., beam size upon incidence on the glass, incidence angle, cross-sectional beam profile, etc.).

At block 610, optical distortion performance is measured and downstream processing is performed. For example, after the laser energy is applied to the ribbon of glass-forming material 103 in accordance with the power profile determined at block 608, another ribbon section can be cut and optical distortion performance can be measured using a commercially available optical distortion gauge. If a desired optical distortion performance is met, downstream processing is performed (e.g., one or more of cleaning, edge finishing, strengthening via ion exchange or thermal treatments, applications of coatings and or surface treatments). If it is determined that the target thickness profile has not been achieved, method 600 can be reconfigured and used to generate another target thickness profile for controlling the laser energy.

In embodiments, the thickness profile 321 of the ribbon of glass-forming material 103 may have some time dependency inherent to the operation of the glass-forming apparatus 100 (apart from the laser). Such fluctuation in baseline thickness profile may alter the laser power profile needed to obtain a thickness profile having attributes associated with low optical distortion. Accordingly, in embodiments, to properly control the laser apparatus 335, the method 600 accounts for such time variability by continuously updating the target thickness profile from iteration to iteration (or after a predetermined number of iterations, or after a predetermined time period) of the method 600 (irrespective of any particular optical distortion performance being achieved in preceding iterations). As shown in FIG. 6A, for example, after an initial glass article is formed (during an initial iteration of the method 600), the method 600 may revert back to step 602. The thickness sensor 301 may periodically or aperiodically measure the thickness profile 321 without any laser energy being applied to the ribbon of glass-forming material 103 to generate a nominal thickness profile yₙₒₘ, which may vary unpredictably in time due to variations in the glass manufacturing apparatus 100. In addition the thickness profile 321 may be measured with laser energy being applied (i.e. the laser profile determined at the previous control iteration) to the ribbon of glass-forming material 103 to generate a thickness prolife for feedback control.

The target thickness profile may then be updated via performance of the blocks 604, 606, and 608 described herein. A thickness profile y(k+1) measured at time k+1 (where k is an integer representing a time sampling increment) can be modeled as a linear matrix equation as

y(k+1)=G*U(k)+yₙₒₘ (2)

where G is a sensitivity matrix (G can be constant and updated occasionally by an in-situ system identification) that relates changes in laser power to changes in thickness of the ribbon of glass forming material 103 and U(k) is a vector of laser power magnitudes that is applied to the ribbon on the preceding iteration. It has been observed that yₙₒₘ has substantial time drift, which necessitates persistent time-dependent laser based feedback control.

In Equation 2, values for the vector U(k) are determined via blocks 604, 606, and 608 of the method 600 as follows. The measured thickness, or a low pass filtered version of the measured thickness, or a high pass filtered version of the measured thickness, or a bandpass filtered thickness version of the measured thickness can provide the target thickness profile target. The type of filtering depends on what thickness variation is sufficiently persistent so as to be compensated The smoothing operation at block 604 is a low pass filtering of the thickness profile 321 at the time k, which, after offsetting, is used as the target thickness profile 331. Taking the difference between the target thickness profile 331 and the measured thickness profile 321 yields the high frequency components of the measured thickness profile 321, which can significantly contribute to the optical distortion performance. It has been observed that the low frequency components of y(k) were in one type of application highly variable, yet the high frequency components are persistent enough to facilitate effective control of the laser. Accordingly, if the low frequency filtering operation performed by the smoothing is expressed as a filter F( ), a control model can be expressed as

y(k+1)−F(y(k+1))=G*U(k)+yₙₒₘ−F(yₙₒₘ). (3)

In Equation (3), the 1−F( ) operation performed is a high pass filtering operation.

An important consideration is the type of filtering that should be selected for the operation F( ). Under steady state conditions, a linear high pass filter, 1−F( ), when applied repeatedly eventually reduces the signal to 0. Spline filtering however does not have that undesirable steady state behavior is therefore a suitable filtering approach. In embodiments, such a spline filter can be represented by a function g(x) that represents an approximation of the measured thickness profile y. Numerical techniques can be used to find a function g(x) that minimizes

$${{Σ}_{i = 1}^{n} ( {y}_{i} - g ( {x}_{i} ) )}^{2} + λ \int {g}^{″} ( t ) d t \qquad ( 4 )$$

where λ is a non-negative tuning parameter that weights the integrated value of the second derivative against the sum of squared error between the smoothing spline and the measured thickness profile y(x). The larger the value of λ, the smoother the spline function becomes.

In view of the forgoing, a final control model for the laser power vector U(k) becomes:

y_{f}(k+1)=G(k)*U(k)+ . . . β_{f}, (5)

Where f represents the high pass filtering operation of 1−F( ) and β_{f} represents yₙₒₘ after the high pass filtering. Equation 5 is in a form that can be used as the model within a standard model predictive control framework. This seeks to minimize at each time step a weighted difference between the forecasted thickness prolife and the thickness profile target, subject to constraints.

The preceding approach descried herein with respect to FIG. 6A relies on using thickness profile measurements to control laser power as a function of time. That is, the thickness profile is used as a proxy for the ultimate objective of fabricating glass articles with minimal levels of optical distortion. In embodiments, optical distortion can be measured on the ribbon of glass-forming material 103 directly and those measurements can be used to control operation of the laser apparatus 335. Such an alternative framework is represented by the method 612 depicted in FIG. 6B. When fabricating glass articles based on an objective defined by an optical distortion target (e.g., zero optical distortion), directly measuring optical distortion of the ribbon is beneficial over a control method based on thickness profile for a number of reasons. First, it is believed that direct measurement of optical distortion allows for more accurate and efficient control of the laser apparatus 335. Such efficient control of laser apparatus 335 can improve the lifetime of various optical components in the system and reduce total cost of operation. It is also believed that, when compared to methods based on measured thickness profiles, measuring optical distortion directly can result in faster tuning with more precision, resulting in higher yield.

At block 614, the optical distortion of the ribbon of glass-forming material 103 can be measured. For example, in addition to (or instead of) the thickness sensor 301, the glass manufacturing apparatus 100 can include an optical distortion gauge, such as the SCREENSCAN-Faultfinder®, supplied by ISRA VISION AG, configured to detect optical distortion maps of the ribbon of glass forming material 103 either prior to or after separation. In embodiments, the first ribbon portion 401 can be measured for optical distortion using a commercially available optical distortion gauge. The optical distortion can be measured at any orientation (defined by the rake and cross-viewing angles described herein). In embodiments, for example, the optical distortion can be measured at an inclination angle, or pitch, (see the rake angle α depicted in FIG. 2A) of 60°, 65°, 70°, or even greater; and a yaw angle relative to a horizontal direction (see the cross-viewing angle B depicted in FIG. 2B) of 20°, 25°, 30°, 35°, or even greater. In embodiments, only a vertical optical distortion map is used to control the laser apparatus 335. In embodiments, only a horizontal optical distortion map is used to control the laser apparatus 335. In embodiments, a combination of vertical and horizontal optical distortion maps (e.g., the vertical and horizontal optical distortion maps can be added to one another) can be used to control the laser apparatus 335.

At block 616, the control device 325 controls the laser apparatus 335 based on differences between the measured optical distortion and an optical distortion target to apply laser power to the ribbon of glass-forming material 314. In embodiments, the optical distortion target is 0 millidiopters, though embodiments where the optical distortion target is non-constant and non-zero in at least one location are also contemplated and within the scope of the present disclosure. In embodiments, the laser apparatus 335 is controlled based on the optical distortion measurements using a model predictive control framework or other method common in the field of automatic feedback control. As described herein, optical distortion can be thought of as localized lensing effects caused by variations in the surfaces of the ribbon from a perfectly flat shape. The optical power of such localized lensing effects can be approximated using the thin lens model as

$$\frac{1}{f} \approx ( n - 1 ) [ \frac{1}{{R}_{1}} - \frac{1}{{R}_{2}} ] \qquad ( 6 )$$

where f is the focal point of a particular point on the ribbon, R₁ is the local radius of curvature of the first major surface 215 (see FIG. 4) and R₂ is the local radius of curvature of the second major surface 216. From the definition of radius of curvature in Equation 1, and approximating the first derivative of the thickness profile as zero for the case of flat ribbon production, one can approximate the optical power P(x) as

$$P ( x ) = ( n - 1 ) \frac{{d}^{2}}{d {x}^{2}} ( Thic kness ( x ) ) . \qquad ( 7 )$$

Given Equation (7), a sensitivity matrix G_{od} that relates changes in laser power to changes in optical distortion of the ribbon of glass forming material 103 can be formulated. In embodiments Gₒₖ can represent a sensitivity of laser power relatively to the second derivative of the thickness profile. In embodiments G_{od} can be calculated by differentiating twice along the columns of the matrix G in Equation 2 herein. This differentiation can be performed without concern of amplifying noise since the columns of G have been shown empirically to be well approximated by Gaussian functional form and so the second derivatives can easily be estimated from differentiating the Gaussian fits.

Given the formulation of G_{od} from G, a control model implemented by the control device 325 to control operation of the laser beam 335 based on the optical distortion map can be similar to that described herein with respect to FIG. 6A. Indeed, a suitable control objective can be formulated into standard model predictive control form, where to the model is now

OD(k+1)=G_{od}*LaserPower(k)+ODₙₒₘᵢₙₐₗ (8)

where LaserPower(k) is a vector of laser power magnitudes that is applied to the ribbon on the preceding iteration and ODₙₒₘᵢₙₐₗ is a vector of nominal optical distortion measurements for the ribbon without modification by laser power. LaserPower(k) can be determined so that G_{od}*LaserPower(k)+ODₙₒₘᵢₙₐₗ approximates a suitable target optical distortion level. With a target optical distortion level of zero, this approach directly measures and seeks to minimize optical distortion. In embodiments, LaserPower(k) can be determined automatically by the control device 325 based on direct optical distortion measurements of the ribbon using a suitable model predictive control method.

### EXAMPLES

Embodiments of the present disclosure may be further understood in view of the following examples.

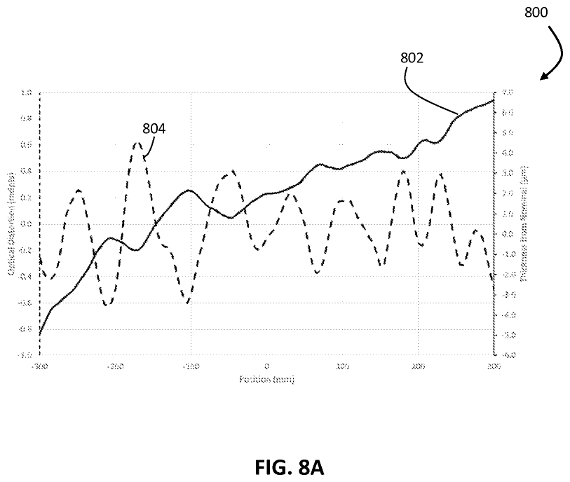

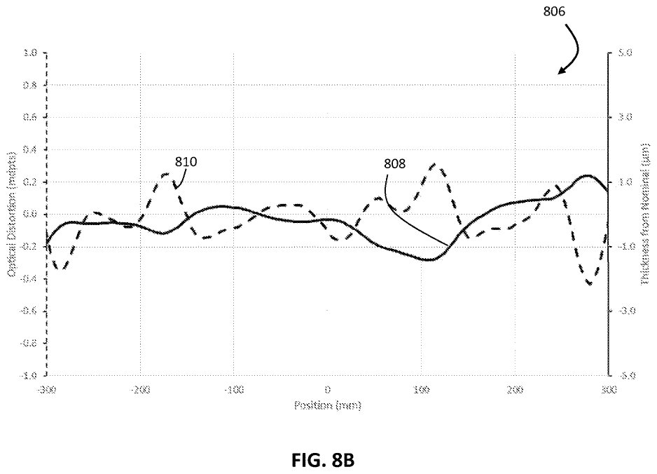

Referring now to FIG. 8A, a plot 800 including a segment of a thickness profile measured on a first example glass ribbon section is shown. The glass ribbon was formed using the method 600 described herein. The glass melted was a fusion-formable borosilicate glass composition having the composition in the Table 1 below. The glass ribbon was formed using a nominal target thickness of 3.8 mm. The plot 800 includes a thickness profile segment 802 and a predicted optical distortion profile 804 for the thickness profile segment 802 (which is 600 mm long in the width direction perpendicular to the drawlines) of the ribbon prior to the ribbon being separated. The thickness profile segment 802 was measured using a chromatic interferometer. A thickness measurement was taken every 5 mm interval (in the width direction) to generate the shown thickness profile segment 802. The measured thickness profile was smoothed using a 20 mm moving average to smooth out noise present in the data due to the ribbon moving during the measurements. Thickness profiles on separated ribbon portions may not need such a correction in other examples. The smoothed measurements are represented in the thickness profile segment 802 provided in FIG. 8A. To generate the predicted optical distortion profile 804, a second order polynomial was fit to the thickness profile segment 802 using a least squares curve fitting algorithm. In generating the second order polynomial, all data points within 10 mm of each data point were used (so that a total of 5 points were used in sampling the thickness profile 802 to generate the second order polynomial). The coefficient of the quadratic term was then used as an approximation for the second derivative of the thickness profile segment 802. This approximation of the second derivative was used to calculate P(x) in accordance with Equation 7 herein, which represents the predicted optical distortion profile 804 depicted in FIG. 8A.

TABLE 1

| Example | Content (mol. %) |
|---|---|
| SiO₂ | 75.93 |
| Al₂O₃ | 3.46 |
| B₂O₃ | 12.65 |
| Na₂O | 5.20 |
| K₂O | 0.92 |
| MgO | 1.74 |
| CaO | 0 |
| SnO₂ | 0.06 |
| Fe₂O₃ | 0.04 |

As shown in FIG. 8A, the thickness profile segment 802 was substantially flat over the represented 600 mm segment, exhibiting an overall thickness range of less than 12 μm over the 600 mm segment. The thickness range was approximately 0.316% of the nominal target over the entire 600 mm segment. Such thickness variation represents a non-constant target thickness profile being used to achieve the favorable optical performance results described herein. As demonstrated by the predicted optical distortion profile 804, the predicted optical distortion (computed using Equation 7 above assuming n to be 1.5) had a range (maximum−minimum value over the entire segment) of about 1.2 millidiopters. Thus, as a percentage of the target thickness in mm, the range of optical distortion in millidiopters was less than 33% (about 31.5%). The maximum magnitude of the predicted optical distortion is about 0.6 millidiopters (about 15.8% of the target thickness in mm). It is believed maximum magnitudes that are as low as 2% of a target minimum thickness are achievable via the methods described herein. Indeed, the predicted optical distortion was only above 0.4 millidiopters over about 60 mm (10%) of the 600 mm segment. For comparison, a similar measurement was taken over a 600 mm segment of another ribbon without being modified with the laser beam as described herein. This ribbon segment had a maximum predicted optical distortion amplitude of about 1.6 millidiopters, or about 42.1% of the target thickness in millidiopters. The predicted optical distortion had a range of about 3.1 millidiopters over the 600 mm segment. Moreover, a majority (more than 50%) of the 600 mm segment had a predicted optical distortion value of over 0.5 millidiopters. These results demonstrate the capabilities of the methods described herein to reduce optical distortion by more than a factor of two. Due to the relatively small overall variation in thickness of 0.316% over the represented segment, ranges for percentages of optical distortion discussed in this paragraph relative to a target value of the thickness are also generally applicable to an average value of the thickness.

Referring now to FIG. 8B, a plot 806 including a segment of a thickness profile measured on a second example glass ribbon section is shown. The glass ribbon was formed using the method 600 described herein. The second example was formed of the same composition as the first example and using a nominal target thickness of 0.522 mm. The plot 806 includes a thickness profile segment 808 and a predicted optical distortion profile 810 for the thickness profile segment 808 (which is 600 mm long in the width direction perpendicular to the drawlines) of the ribbon prior to the ribbon being separated. The thickness profile segment 808 and predicted optical distortion profile 810 were generated using the same techniques as those described herein with respect to the first example glass ribbon section. As shown in FIG. 8B, the thickness profile segment 808 was substantially flat over the represented 600 mm segment, exhibiting an overall thickness range of less than 2.7 μm over the 600 mm segment. The thickness range was approximately 4.95% of the nominal target over the entire 600 mm segment. Such thickness variation represents a non-constant target thickness profile being used to achieve the favorable optical performance results described herein. As demonstrated by the predicted optical distortion profile 810, the predicted optical distortion (computed using Equation 7 above assuming n to be 1.5) had a range (maximum−minimum value over the entire segment) of about 0.65 millidiopters. Thus, as a percentage of the target thickness in mm, the range of optical distortion in millidiopters was less than 150% (about 124%). The maximum magnitude of the predicted optical distortion is about 0.425 millidiopters (about 80% of the target thickness in mm). Indeed, the predicted optical distortion was only above 0.4 millidiopters over less than 10% of the overall length of the segment. For comparison, a similar measurement was taken over a 600 mm segment of another ribbon without being modified with the laser beam as described herein (having the same target thickness). This ribbon segment had a maximum predicted optical distortion amplitude of about 0.85 millidiopters, or about 162% of the target thickness in millidiopters. The predicted optical distortion had a range of about 1.3 millidiopters over the 600 mm segment. Moreover, a much higher portion of the 600 mm segment had a predicted optical distortion value of over 0.4 millidiopters. The predicted optical distortion profiles depicted in FIGS. 8A-8B demonstrate that, as expected, the overall range and maximum values for predicted optical distortion generally decrease with decreasing thickness. Glass ribbons formed at thickness of less than 3.8 mm are expected to exhibit ranges of predicted optical distortion values that are less than 1.2 millidiopters. Maximum magnitude predicted optical distortion values are expected to show a similar trend.

It is believed that fusion-forming processes exhibit better thickness uniformity with reduced target thickness for glass ribbons. As such, it is believed that the extent of optical distortion reduction provided via the methods described herein will reduce with decreasing target thickness. However, application of laser energy via the methods described herein will generally reduce maximum values of optical distortion exhibited by the glass articles over comparable glass articles without being modified by laser energy in accordance with the methods described herein. In embodiments, glass articles in accordance with the present disclosure may comprise a thickness that is greater than or equal to 0.05 mm and less than or equal to 6.0 mm (e.g., greater than or equal to 0.05 mm and less than or equal to 4.0 mm). Moreover, along a line extending between edges of the glass article in a first direction (e.g., perpendicular to the drawlines) and having a length of at least 50% of the length of the glass article in the first direction, the thickness comprises a range that may be greater than or equal to 0.05% of an average value of the thickness along the line and less than or equal to 5.0% of the average value (e.g., greater than or equal to 0.01% greater than or equal to 0.2% of the average value and less than or equal to 0.1% of the average value). In such embodiments, a 500 mm segment of the line comprises a range of predicted optical distortion values, calculated as 0.5 times a second derivative of a thickness profile along the line, that is less than or equal to 2.0 millidiopters. In some embodiments, the maximum magnitude of the predicted optical distortion values (in millidiopters) is less than 85% of the average value (in mm) and the maximum magnitude can be less than or equal to 20% of the average value (in mm). In some embodiments, the range of predicted optical distortion values is less than 150% of the average value (in mm), or even less than 100% of the average value, or even less than 50% of the average value, or even less than 33% of the average value (e.g., for embodiments where the average is greater than or equal to 3.8 mm). Along the line, the predicted optical distortion values can be less than 0.5 millidiopters over a majority of the 500 mm segment, even when the thickness is greater than or equal to 2.0 mm, or even greater than or equal to 3.0 mm and less than or equal to 4.0 mm. Such thickness and distortion ranges can even be exhibited when the length of the line is greater than or equal to 1000 mm (such the length of the article is greater than or equal to 2000 mm). The “predicted optical distortion” values herein are not measured directly, but rather are calculated from a measured thickness profile.

Vertical and horizontal optical distortion measurements were taken for glass articles formed from ribbons having comparable construction (e.g., thickness target of 3.8 mm) to that represented in FIG. 8 above. Vertical and horizontal optical distortion measurements were taken, with the vertical direction being the direction in which the drawlines in the glass article extend (parallel to the draw direction). The measurements were taken with the glass article having a relatively large angle (above 60°) relative to vertical (to simulate a rake angle α depicted in FIG. 2A) and a relatively large cross-viewing angle above 200 (to simulate a large field of view 8 depicted in FIG. 2B). Without laser treatment, a maximum (99.9%) value for the horizontal distortion was about 84.0 millidiopters, while the maximum (99.9%) value for the vertical distortion was 25.3 millidiopters. With laser treatment, a maximum (99.9%) value for the horizontal distortion was about 58.8 millidiopters, while the maximum (99.9%) value for the vertical distortion was 15.3 millidiopters. Performance of the method 600 was thus able to reduce the maximum vertical optical distortion value by nearly 50% and also reduce horizontal optical distortion values. Indeed, the sum of the maximum vertical and horizontal optical distortion values was less than 80 millidiopters for the examples with laser treatment. Given that measured distortion values increase with increasing angle of incidence, the treated examples are believed to exhibit maximum vertical optical distortion of less than 15.3 millidiopters when at an angle of 60° relative to vertical and less than 58.8 millidiopters when measured at a cross viewing angle of 20° relative to horizontal.

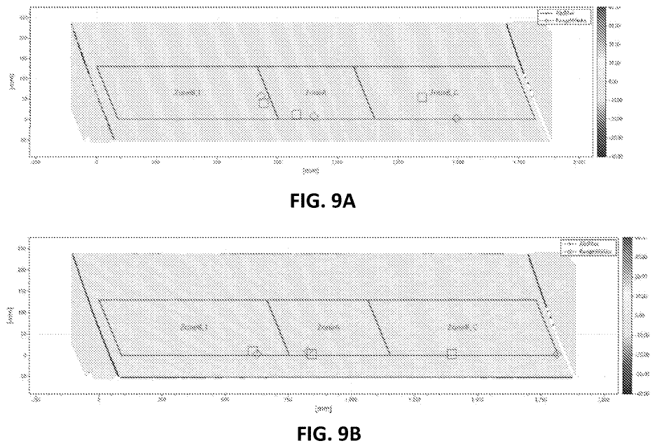

FIGS. 9A and 9B are optical distortion maps of a second example glass article formed via the methods described herein. The second example had the same composition and target thickness as the first example glass ribbon described herein with respect to FIG. 8A. Vertical and horizontal optical distortion maps were measured using a commercially available optical distortion gauge. The measurements were taken at a rake angle of 60° relative to vertical and a 20° cross-viewing angle with respect to the horizontal direction. FIG. 9A is a vertical optical distortion map and FIG. 9B is a horizontal optical distortion map. As shown in FIG. 9A, the vertical optical distortion values were less than 10 millidiopters over more than one-third of surface area of the glass article. As shown in FIG. 9A, the horizontal optical distortion values were less than 10 millidiopters over more than 50% of the surface area of the glass article. Maximum values of the measured optical distortion are provided in the Tables 1 and 2.

TABLE 1

| Vertical | Zone B | Zone A | Zone C |
|---|---|---|---|
| Abs. Max | 9.17 | 9.35 | 9.03 |
| Abs. 99.9% | 8.15 | 8.19 | 7.17 |

TABLE 2

| Horizontal | Zone B | Zone A | Zone C |
|---|---|---|---|
| Abs. Max | 9.65 | 8.34 | 6.83 |
| Abs. 99.9% | 8.13 | 6.89 | 5.48 |

As shown, the maximum values (both absolute and 99.9%) of both the horizontal and vertical optical distortion maps are less than 10 millidiopters. Indeed, a sum of a 99.9% maximum horizontal optical distortion value and a 99.9% maximum vertical optical distortion value is less than 16.5 millidiopters. Such consistently low optical distortion values across the article demonstrates the efficacy of the methods described herein in providing articles having superior optical distortion performance, thereby facilitating use of high-resolution sensing technology at relatively high fields of view. In aspects, it is believed that that glass articles described herein can have a thickness of greater than or equal to 0.05 mm and less than or equal to 4.0 mm and exhibit 99.9% maximum vertical and optical distortion values that are less than 10 millidiopters in zones excluding peripheries of the articles proximate to the edges. Such low optical distortion values at high thicknesses (e.g., greater than or equal to 3.0 mm and less than or equal to 4.0 mm) can facilitate placement of high resolution sensors behind glass articles formed via the methods described herein (e.g., as a component of a windshield, as a separate sensor window). Articles formed via the methods described herein can therefore facilitate improvement in the operation of ADAS systems and other sensors placed inside the cabins of vehicles, providing design flexibility.

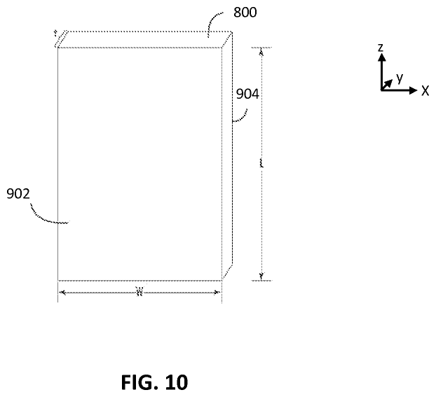

Referring now to FIG. 10, various structural and compositional details of the glass substrate 900 formed via the methods described herein will now be provided. The glass substrate 900 may correspond to the window 24, or one of the first and second glass substrates 52 and 56 described herein with respect to FIGS. 1A-2B. In embodiments the glass substrate 900 has a thickness t that is substantially constant over the width and length of the glass substrate 900, but with some variation, as described herein. The thickness t is defined as a distance in a first direction (the y-direction) between the first major surface 902 and the second major surface 904. In various embodiments, the thickness varies from a nominal target and includes drawlines extending generally parallel to one another in a draw direction (corresponding to the travel direction 154 depicted in FIG. 3). Such drawlines may comprise contours where the thickness is substantially constant extending in the draw direction (such that the thickness t varies to a greater extent in a direction perpendicular to the draw direction). Such drawlines are observable to those skilled in the art using known techniques. The nominal target for the glass substrate 900 may be any of the values described herein with respect to the first and second glass substrates 52 and 56, or the ribbon of glass-forming material 103.

As shown in FIG. 10, the glass substrate 900 includes a width W defined as a first maximum dimension of one of the first or second major surfaces 902, 904 orthogonal to the thickness t, and a length L defined as a second maximum dimension of one of the first or second major surfaces 902, 904 orthogonal to both the thickness and the width. The width W is measured in a second direction (the x-direction) extending perpendicular to the first direction and the length L is measured in a third direction (the z-direction) extending perpendicular to the first and second directions. In embodiments, the glass substrate 900 can be cut (e.g., from the ribbon of glass-forming material 103) so that the drawlines extend in one of the second and third directions. For example, in embodiments, the drawlines may extend in the second direction (parallel to the W) so that the thickness t varies along the third direction (parallel to the length L) as a result of the drawlines. Unless otherwise noted herein, vertical optical distortion (VOD) measurements are taken in a direction parallel to that which the drawlines extend.

In embodiments, both L and W can be greater than or equal to 100 mm (e.g., greater than or equal to 200 mm, greater than or equal to 300 mm, greater than or equal to 500 mm, greater than or equal to 1000 mm) and less than or equal to 5000 mm. The substrate 900 can exhibit a thickness profile such as the thickness profile 802 described herein with respect to FIG. 8, with the thickness profile being taken perpendicular to the drawlines, with the drawlines extending in the widthwise direction (such that the thickness profile is in the lengthwise direction perpendicular to the drawlines). In embodiments, such thickness profiles can include segments that are at least 500 mm in length where the thickness t has a range (maximum−minimum) that is less than 1% of an average value of the thickness t over that segment. In embodiments, the length L is greater than or equal to 2000 mm and such thickness profiles may include segments that are 1000 mm in length where the thickness has a range that is greater than or equal to 0.05% and less than or equal to 0.8% of an average value (e.g., greater than or equal to 0.2% and less than or equal to 0.8%). Such thickness uniformity may be present all while the glass articles exhibit the favorable optical distortion attributes described herein. Such characteristics enable favorable performance for a variety of applications, including protective sensor covers, automotive glazings, mobile consumer electronics, and display applications.

It will be apparent to those skilled in the art that various modifications and variations can be made without departing from the spirit or scope of the claims.

1. A glass article comprising:
a first major surface;
a second major surface disposed opposite the first major surface;
a thickness measured between the first major surface and the second major surface in a direction perpendicular to the first and second major surfaces; and
a plurality of drawlines extending in a first direction, wherein:
the thickness is greater than or equal to 0.05 mm and less than or equal to 6.0 mm,
the glass article exhibits a maximum vertical optical distortion (VOD), with a vertical direction being parallel to the first direction, that is less than or equal to 16 millidiopters when the glass article is oriented at an inclination angle of 60° relative to the vertical direction, and
the glass article exhibits a maximum horizontal optical distortion (HOD), with a horizontal direction being perpendicular to the vertical direction, that is less than or equal to 60 millidiopters when the glass article is oriented at a cross-viewing angle of 20° relative to the horizontal direction.

2. The glass article according to claim 1, wherein a sum of the VOD and the HOD is less than or equal to 20 millidiopters.

3. The glass article according to claim 1, wherein one or more of:
6 millidiopters≤VOD≤10 millidiopters, and
6 millidiopters≤HOD≤10 millidiopters.

4. (canceled)

5. The glass article according to claim 1, wherein:
the glass article comprises a length measured in the horizontal direction,
the length is greater than or equal to 500 mm, and
along a line in the horizontal direction having a profile length that is at least 50% of the length, thickness comprises a range that is greater than or equal to 0.05% of an average value of the thickness along the line and less than or equal to 5.0% of the average value.

6. (canceled)

7. The glass article according to claim 5, wherein a 500 mm segment of the line comprises a range of predicted optical distortion values, calculated as 0.5 times a second derivative of a thickness profile along the line, that is less than or equal to 2.0 millidiopters.

8. The glass article according to claim 7, wherein a maximum magnitude of the predicted optical distortion values (in millidiopters) is less than 80% of the average thickness (in mm).

9. The glass article according to claim 5, wherein the length is greater than or equal to 2000 mm, and wherein the range of predicted optical distortion values is less than 150% of the average thickness (in mm).

10. The glass article according to claim 5, wherein the length is greater than or equal to 2000 mm, and wherein the predicted optical distortion values are less than 0.5 millidiopters over a majority of 500 mm segment.

11. The glass article according to claim 1, wherein an average value of the thickness is greater than or equal to 2.0 mm.

12. (canceled)

13. The glass article according to claim 1, wherein the glass article comprises a borosilicate glass composition.

14. A glass article comprising:
a first major surface;
a second major surface disposed opposite the first major surface; and
a thickness measured between the first major surface and the second major surface in a direction perpendicular to the first and second major surfaces, wherein:
the thickness comprises an average value that is greater than or equal to 0.05 mm and less than or equal to 4.0 mm
along a line extending between edges of the glass article in a first direction, thickness comprises a range that is greater than or equal to 0.05% of an average value of the thickness along the line and less than or equal to 5.0% of the average value, and
a 500 mm segment of the line comprises a range of predicted optical distortion values, calculated as 0.5 times a second derivative of a thickness profile along the line, that is less than or equal to 2.0 millidiopters.

15. The glass article according claim 14, wherein the average value is greater than or equal to 2.0 mm.

16. (canceled)

17. The glass article according to claim 15, wherein a maximum magnitude of the predicted optical distortion values (in millidiopters) is less than 80% of the average value (in mm).

18. The glass article according to claim 15, wherein the range of predicted optical distortion values is less than 150% of the average value (in mm).

19. The glass article according to claim 15, wherein the predicted optical distortion values are less than 0.5 millidiopters over a majority of the 500 mm segment.

20. The glass article according to claim 15, wherein the glass article comprises a length measured in the first direction, the length being greater than or equal to 1000 mm.

21. The glass article according to claim 20, wherein:
the glass article exhibits a maximum vertical optical distortion (VOD), with a vertical direction being perpendicular to the first direction, that is less than or equal to 16 millidiopters when the glass article is oriented at an inclination angle of 60° relative to the vertical direction, and
the glass article exhibits a maximum horizontal optical distortion (HOD), with a horizontal direction being perpendicular to the vertical direction, that is less than or equal to 25 millidiopters when the glass article is oriented at a cross-viewing angle of 20° relative to the horizontal direction.

22. The glass article according to claim 21, wherein a sum of the VOD and the HOD is less than or equal to 20 millidiopters.

23. The glass article according to claim 21, wherein one or more of:
6 millidiopters≤VOD≤10 millidiopters, and
6 millidiopters≤HOD≤10 millidiopters.

24. (canceled)

25. The glass article according to claim 14, wherein the glass article comprises a borosilicate glass composition.

26.-41. (canceled)
